(19) United States
(12) Patent Application Publication
(10) Pub. No.: US 2020/0349520 A1
(43) Pub. Date: Nov. 5, 2020

(54) SYSTEMS AND METHODS FOR EXCHANGING DIGITAL CARDS

(71) Applicant: XapCard Inc., Toronto (CA)

(72) Inventor: Ghazanfar Ahmed Mughal, Toronto (CA)

(21) Appl. No.: 16/861,536

(22) Filed: Apr. 29, 2020

Related U.S. Application Data
(60) Provisional application No. 62/840,515, filed on Apr. 30, 2019.

(51) Int. Cl. G06Q 10/10; H04W 12/00; H04W 12/06; H04L 9/32; H04W 4/02; H04B 17/318; H04W 76/14; H04W 4/80; G01C 17/02

(52) U.S. Cl. CPC G06Q 10/109; H04W 12/0013; H04W 12/0609; H04L 9/3263; G06Q 2220/00; H04B 17/318; H04W 76/14; H04W 4/80; G01C 17/02; H04W 4/026

(57) ABSTRACT

Systems and method for exchanging digital cards are provided. The discovery of one or more transmitting devices broadcasting one or more information signals is provided. The signal discovery includes the selection of an ideal transmitting device associated with an information signal. When an ideal transmitting is identified, methods and systems for connection are provided to exchange a digital card.

### CROSS REFERENCE TO RELATED APPLICATIONS

This application claims the benefit of U.S. Provisional Application No. 61/840,515 filed on Apr. 30, 2019, which is incorporated by reference herein in its entirety.

### FIELD

The described embodiments relate to systems and methods for exchanging digital cards, and in particular, to systems and methods for exchanging digital cards in a networked and a non-networked environment.

### BACKGROUND

Traditionally individuals have connected and networked with each other by exchanging paper cards having printed information, such as name, occupation, address, contact information etc. Such paper business cards assist individuals to stay in contact subsequent to the initial meeting. This existing solution however is inefficient since it requires a manual organization of an individual's collected cards, or the data entry of the printed contact information into a computer. There is a need to improve the means for exchanging relevant information with others to establish connections.

### SUMMARY

In a first aspect, some embodiments provide a system for receiving a digital card. The system comprises one or more transmitting devices, where each of the one or more transmitting devices comprises a first wireless transceiver and a first processor. The first processor is configured to encode a device orientation indicia in a first plurality of information signals; and transmit, using the first wireless transceiver, the first plurality of information signals. The system further comprises a second computing device, where the second computing device comprises a second wireless transceiver and a second processor. The second processor is configured to: receive a plurality of incoming information signals from the second wireless transceiver, the plurality of incoming information signals corresponding to the one or more transmitting devices, each of the plurality of incoming information signals having a corresponding device orientation indicia, and the plurality of incoming information signals comprising at least one of the first plurality of information signals; determine a signal strength of each incoming information signal; determine an ideal transmitting device from the one or more transmitting devices based on the device orientation indicia and the signal strength of each incoming information signal; and establish a connection with the ideal transmitting device.

In some embodiments, each transmitting device further comprises a device orientation sensor, and the device orientation indicia corresponding to that transmitting device is based on a measurement by the device orientation sensor.

In some embodiments, the second processor is further configured to determine an offset angle for each incoming information signal based on a receiving device orientation and the device orientation indicia contained in that information signal, and wherein the ideal transmitting device is determined based on the offset angle and the signal strength of each incoming information signal.

In various embodiments, the second processor is further configured to determine a ranking score for each of the plurality of incoming information signals, the ranking score determined based on a weighted linear combination of the signal strength and the offset angle; and identify the ideal transmitting based on the incoming information signal with a highest-ranking score.

In various embodiments, the second processor is further configured to: filter the plurality of incoming information signals based on a signal strength threshold, wherein the one or more information signals with a corresponding signal strength higher than the signal strength threshold are grouped to identify a first set of qualifying information signals; filter the first set of qualifying information signals based on an orientation threshold, wherein the one or more information signals from the first set of qualifying information signals with an offset angle smaller than the orientation threshold are grouped to identify a second set of qualifying information signals; and rank the second set of qualifying information signals based on the corresponding signal strengths.

In some embodiments, the first orientation sensor is a magnetic compass located within the corresponding transmitting device.

In some embodiments, the plurality of information signals are transmitted using a short-distance wireless communications network. In some embodiments, the short-distance wireless communications network is a Bluetooth Low Energy based network.

In various embodiments, the second computing device further comprises a second display user interface, wherein the second processor is further configured to: display the one or more transmitting devices associated with the plurality of incoming information signals on a map on the second display user interface, wherein the location of each transmitting device on the map is based on the signal strength and the device orientation indicia associated with the corresponding information signal.

In another aspect, in at least one embodiment described herein, there is provided a method of receiving a digital card, comprising: receiving, at a receiving device, one or more incoming information signals, the one or more incoming information signals corresponding to one or more transmitting devices, each of the one or more incoming information signals having a device orientation indicia; determining, at the receiving device, an offset angle for each incoming information signal based on a receiving device orientation and the device orientation indicia contained in the corresponding incoming information signal; determining a signal strength of each incoming information signal; determining an ideal transmitting device based on the offset angle and the signal strength of each information signal; and establishing the connection between the ideal transmitting device and the receiving device.

In some embodiments, determining the ideal transmitting device further comprises determining a ranking score for each of the plurality of incoming information signals, the ranking score determined based on a weighted linear combination of the signal strength and the offset angle; and identifying the ideal transmitting based on the incoming information signal with a highest-ranking score.

In some embodiments, determining the ideal transmitting device further comprises: filtering the plurality of incoming information signals based on a signal strength threshold, wherein the one or more information signals with a corresponding signal strength higher than the signal strength threshold are grouped to identify a first set of qualifying information signals; filtering the first set of qualifying information signals based on an orientation threshold, wherein the one or more information signals from the first set of qualifying information signals with an offset angle smaller than the orientation threshold are grouped to identify a second set of qualifying information signals; and ranking the second set of qualifying information signals based on the corresponding signal strengths.

In various embodiments, the plurality of incoming information signals are transmitted using a short-distance wireless communications network. In some embodiments, the short-distance wireless communications network is a Bluetooth Low Energy based network.

In various embodiments, the method further comprises displaying the one or more transmitting devices associated with the plurality of incoming information signals on a map on a second display user interface, wherein the location of each transmitting device on the map is based on the signal strength and the device orientation indicia associated with the corresponding information signal.

In another aspect, in at least one embodiment described herein, there is provided a system for receiving a digital card. The system comprises a transmitting device, where the transmitting device comprises a transmitting device wireless transceiver; and a transmitting device processor. The transmitting device processor is configured to: receive, using the transmitting device wireless transceiver, a signed public certificate from a receiving device; validate the signed public certificate received from the receiving device; transmit, using the transmitting device wireless transceiver, a signed public certificate associated with the transmitting device to the receiving device; receive, using the transmitting device wireless transceiver, a request signal from the receiving device, the request signal including a request for a digital card associated with a transmitting device; generate, a signed token in response to the request signal, the signed token being signed using a private key associated with the transmitting device; and transmit, using the transmitting device wireless transceiver, the signed token to the receiving device. The system further comprises the receiving device, which comprise a receiving device wireless transceiver, and a receiving device processor. The receiving device processor is configured to: transmit, using the receiving device wireless transceiver, the signed public certificate associated with the receiving device to the transmitting device; receive, using the receiving device wireless transceiver, the signed public certificate associated with the transmitting device; validate the signed public certificate associated with the transmitting device; transmit, using the receiving device wireless transceiver, the request signal to the transmitting device; receive, using the receiving device wireless transceiver, the signed token from the transmitting device; transmit, using a network, the signed token to a digital card management system; and receive, using the network, a digital card associated with the transmitting device from the digital card management system, the digital card being identified in the signed token.

In a further aspect, in at least one embodiment described herein, there is provided a method of receiving a digital card, comprising: transmitting, by a receiving device, using a short-distance wireless communications network, a signed public certificate associated with the receiving device; receiving, at the receiving device, using a short-distance wireless communications network, a signed public certificate associated with a transmitting device; validating the signed public certificate associated with the transmitting device; transmitting, by the receiving device, using the short-distance wireless communications network, a request signal to the transmitting device, the request signal comprising a request for a digital card associated with the transmitting device; receiving, by the receiving device, using the short-distance wireless communications network, a response signal from the transmitting device, the response signal comprising a signed token, the signed token being signed by a private key associated with the transmitting device; transmitting, by the receiving device, using a network, the signed token to a digital card management system; and receiving, by the receiving device, using the network, the digital card associated with the transmitting device from the digital card management system.

In another aspect, in at least one embodiment described herein, there is provided a system of receiving a digital card, where the system comprises a transmitting device and a receiving device. The transmitting device comprises: a transmitting device wireless transceiver; a signed public certificate associated with the transmitting device; and a transmitting device processor, which is configured to: receive, using the transmitting device wireless transceiver via a short-distance communications network, a signed public certificate associated with a receiving device from the receiving device; validate the signed public certificate associated with the receiving device; transmit, using the transmitting wireless transceiver, the signed public certificate associated with the transmitting device to the receiving device; receive a digital card request corresponding to a digital card associated with the transmitting device, the digital card request being generated by the receiving device; generate a response signal, the response signal comprising an encrypted digital card and a signed token, the encrypted digital card being encrypted based on the signed public certificate associated with the receiving device; and transmit, using the transmitting device wireless transceiver, the response signal to the receiving device. The receiving device comprises a receiving device wireless transceiver; the signed public certificate associated with the receiving device; and a receiving device processor, which is configured to: transmit, using the receiving device wireless transceiver via the short-distance communications network, the signed public certificate associated with the receiving device to the transmitting device; receive, using the receiving device wireless transceiver via the short-distance communications network, the signed public certificate associated with the transmitting device from the transmitting device; validate the signed public certificate associated with the transmitting device; transmit, using the receiving device wireless transceiver via the short-distance communications network, the digital card request to the transmitting device; receive, using the receiving device wireless transceiver via the short-distance communications network, the response signal; and decrypting the encrypted digital card in the response signal based on a private key associated with the receiving device to generate a decrypted digital card.

In various embodiments, the receiving device processor is further configured to subsequently transmit, using a network, the signed token in the response signal to a digital card management system; and receive, using the network, from the digital card management system, the digital card identified in the response signal.

In another aspect, in at least one embodiment described herein, there is provided a method of receiving a digital card, comprising: transmitting, by a receiving device using a short-distance wireless communications network, a public certificate associated with the receiving device; receiving, at the receiving device using a short-distance wireless communications network, a public certificate associated with the transmitting device from a transmitting computing device; validating the signed public certificate associated with the transmitting device; transmitting, by the receiving device, using a short-distance wireless communications network, a digital card request corresponding to the digital card to the transmitting device; receiving, using the short-distance wireless communications network, a response signal, the response signal comprising an encrypted digital card corresponding to the digital card and a signed token, the encrypted digital card being an encrypted version of the digital card associated with the transmitting device, the encrypted digital card being encrypted based on the signed public certificate associated with the receiving device; and decrypting the encrypted digital card based on a private key associated with the receiving device to generate a decrypted digital card.

In various embodiments, the method further comprises subsequently, transmitting using a network, the signed token to a digital card management system; and receiving using the network, from the digital card management system, the digital card.

In a further aspect, in at least one embodiment described herein, there is provided a system of receiving a digital card, where the system comprises a computing device, which comprises a geographical location sensor; and a processor, where the processor is configured to: determine, a user geographical location of the computing device using the geographical location sensor; transmit, a geographical search request to a server, the geographical search request including the geographical location of the computing device; receive, a geographical search response from the server; the geographical search response including one or more user identifiers, and a corresponding one or more digital card tokens; display a map view including one or more user icons on a display device, wherein each of the one or more user icons are arranged on the map view based on the corresponding geographical location; receive a selection input, the selection input identifying a user icon from the one or more user icons arranged on the map view; transmit the digital card token associated with the selected user icon to the server; and receive a digital card corresponding to the selected user icon from the server.

In another aspect, in at least one embodiment described herein, there is provided a method of receiving a digital card, comprising: determining, at a user device, a user geographical location of the user device; transmitting, to a server, a geographical search request, the geographical search request including the geographical location of the user device; receiving, from the server, a geographical search response, the geographical search response including one or more user identifiers and one or more corresponding digital card tokens; displaying a map view including one or more user icons associated with the one or more user identifiers, wherein each of the one or more user icons are arranged on the map view based on the corresponding geographical location; receiving, at a user input device, a selection input, the selection input identifying a user icon from the one or more user icons arranged on the map view; transmitting, to the server, the digital card token associated with the selected user icon; and receiving, from the server, a digital card corresponding to the selected user icon.

In a further aspect, in at least one embodiment described herein, there is provided a system of transmitting a digital card. The system comprises a computing device, where the computing device comprises a memory including a digital card and a signed public certificate; a geographical location sensor; and a processor, where the processor is configured to: determine, a geographical location of the computing device using the geographical location sensor; receive a selection input from a user operating the computing device, the selection input identifying the digital card from one or more digital cards to be exchanged; generate a signed digital card token based on the selected digital card, the signed digital card token being signed with a private key associated with the computing device; and transmit a digital card drop request to a server, the digital card drop request comprising the geographical location of the computing device and the signed digital card token.

In another aspect, in at least one embodiment described herein, there is provided a method of transmitting a digital card, comprising: determining, at a user device, a geographical location of the user device; receiving, at a user input device, a selection input from a user operating the computing device, the selection input identifying the digital card from one or more digital cards to be exchanged; generating, at the user device, a signed digital card token based on the selected digital card, the signed digital card token being signed with a private key associated with the computing device; transmitting, to a server, a digital card drop request, the digital card drop request comprising the geographical location of the computing device and the signed digital card token.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from the detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment and the figures will now be briefly described.

FIG. 1 is an example of a block diagram of a digital card exchange system;

FIG. 2 is an example of a block diagram of a mobile device for exchanging digital cards;

FIG. 3A is an example of a block diagram of a server for exchanging digital cards;

FIG. 3B is an example of a schema diagram of a database for exchanging digital cards;

FIG. 3C is an example of a schema diagram of a database for exchanging digital cards;

FIG. 3D is an example of a schema diagram of a database for exchanging digital cards;

FIG. 4A is an example view of a plurality of mobile devices for exchanging digital cards;

FIG. 4B is another example view of a plurality of mobile devices for exchanging digital cards;

FIG. 4C is another example view of a plurality of mobile devices for exchanging digital cards;

FIG. 4D is a further example view of a plurality of mobile devices for exchanging digital cards;

FIG. 5 is an example of a process flow diagram for exchanging digital cards;

FIG. 6A is an example of a user device interface for transmitting a digital card;

FIG. 6B is another example of a user device interface for receiving a digital card;

FIG. 6C is another example of a user device interface for transmitting a digital card;

FIG. 6D is a further example of a user device interface for receiving a digital card;

FIG. 6E is an example of a user device interface for leaving a digital card at a location;

FIG. 6F is another example of a user device interface for picking up a digital card at a location;

FIG. 7 is an example of a user device interface for displaying a digital card;

FIG. 8 is another example of a user device interface for selecting a privacy setting of a digital card;

FIG. 9A is an example of a map interface for exchanging digital cards;

FIG. 9B is another example of a map interface for exchanging digital cards;

FIG. 9C is an example of a process flow for exchanging digital cards;

FIG. 9D is another example of a process flow for exchanging digital cards;

FIG. 10 is another example of a process flow for exchanging digital cards;

FIG. 11 is another process flow diagram for exchanging digital cards;

FIG. 12A is an example of a process flow diagram for exchanging digital cards; and

FIG. 12B is another example of a process flow diagram for exchanging digital cards.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EXAMPLE EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented such as hardware, software, and combinations thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

The systems and methods disclosed herein generally facilitate exchange of digital cards between user devices. A digital card may be any card that may contain certain information that one user may wish to exchange with one or more other users. Such information may include user's personal information, such as name, occupation, location, contact information, business name, employer's name etc.

A digital card in the context of this application may be any card with various data items, which may or may not be displayed. The digital card may be any shape or layout, and may include video, animations, static text, codes, barcodes, QR codes or any other coded and un-encoded information etc. The digital card may be multidimensional, where each dimension or side may convey a unique item of information about the user. The digital card may also be configurable to a specific privacy mode, such as, private, public, protected etc. Each mode may control certain attributes of the digital card, such as how it is shared, how it is seen by others, how it is used by others etc. A digital card may be a business card, payment card, loyalty card, membership card, appointment card, invitation card, or any other card.

Unlike with the exchange of a physical card, certain challenges exist with the exchange of digital cards. With physical cards, two or more users wishing to exchange cards typically place themselves in physical proximity to each other and communicate their intentions regarding wishing to exchange cards with each other. If a user does not wish to provide or receive a digital card to another user, he/she is able to express his/her intention to the other user, either verbally or through other means, such as hand gestures or facial expressions.

However, with the exchange of digital cards, it may be challenging to determine that a digital card is being sent correctly to an intended recipient. Similarly, it may be challenging to determine if the digital card is being received from an intended sender. Furthermore, a user may desire to leave his/her digital card behind at a location for other users to receive at their convenience. Similarly, a user may desire to receive a digital card left behind at a location by a user at another point in time.

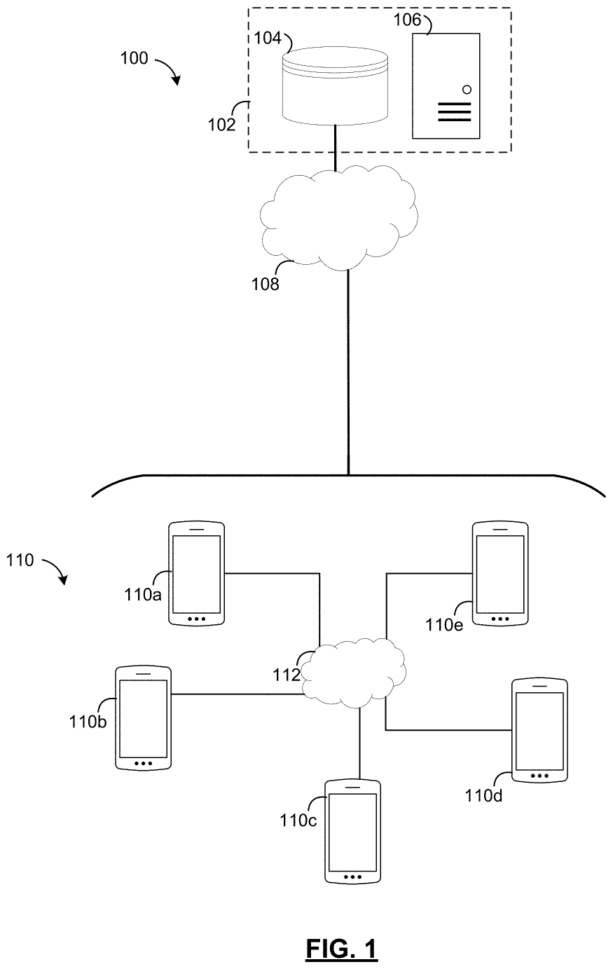

Reference is first made to FIG. 1, which illustrates a schematic block diagram of a digital card exchange system 100. The digital card exchange system 100 includes a plurality of user devices 110 and a digital card management system 102. The digital card management system includes a database 104 and a server 106.

Users (not shown) may each operate user devices 110a-110e in order to exchange digital cards with one another. The users may be at a single venue, such as at a meeting room, in a conference center, an office, or a building, etc. The users may wish to send or receive contact information to and from other users using the digital cards to allow for further communications at a later point in time.

As shown, the digital card exchange system 100 includes a network 108 for connecting the digital card management system 102 and the plurality of user devices 110. The digital card exchange system 100 also includes a local network 112 for allowing the plurality of user devices 110 to communicate with each other. Digital cards may be exchanged with or without network communication between user devices 110a-110e and the digital card management system 102.

Network 108 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

The local network 112 may be any network or network components capable of facilitating wireless communication between devices, including short-wavelength wireless communications networks (for example, Bluetooth® (BT) or Bluetooth Low Energy® (BLE)), radiofrequency identification (RFID) systems, near frequency communication (NFC) enabled networks, and others, including any combination of these. In some cases, the local network 112 may be in communication with network 108. Alternatively, in some other cases, the local network 112 may not be in communication with network 108.

A user device 110 may be any two-way communication device with capabilities to communicate with other devices. A user device 110 may be a mobile devices such as mobile devices running the Google® Android® operating system or Apple® iOS® operating system.

Each user device 110 includes and executes a client application, such as a digital card exchange application, to exchange digital cards. The client application may be a web application provided by server 106 of digital card management system 102, or it may be an application installed on the user device 110, for example, via an app store such as Google® Play® or the Apple® App Store®

By way of an example, the digital card exchange system 100 illustrates five user devices, namely a first user device 110a, a second user device 110b, a third user device 110c, a fourth user device 110d and a fifth user device 110e. It is understood that a digital card exchange system 100 can include any number of user devices.

As shown, the user devices 110 are configured to communicate with digital card management system 102 using network 108. For example, digital card management system 102 may provide a web application or Application Programming Interface (API) endpoint for an application running on user devices 110. The user devices 110a-110e may be in communication with digital card management system 102 using network 108, and this may be referred to as an “online” mode. In an alternate embodiment, the user devices 110a-110e may exchange digital cards in the absence of network 108, and this may be referred to as an “offline” mode.

The digital card management system 102 is any networked computing device or system, including a processor and memory, and is capable of communicating with a network, such as network 108. The digital card management system 102 may include one or more systems or devices that are communicably coupled to each other. The computing device may be a personal computer, a workstation, a server, a portable computer, a mobile phone, a laptop wireless coupled to an access point (e.g. a wireless router, a cellular communications tower etc.), a wirelessly enabled personal data assistant (PDA) or a smart phone, a terminal, a tablet computer, a game console over a wired or wireless connection, a WAP phone, or a combination of these.

The digital card management system 102 manages the accounts of various users of the digital card exchange system 100 and facilitates the exchange of digital cards among the users. For example, the digital card management system 102 may allow users 110 to create user accounts, add user profile information associated with a user account, create digital cards, upload images of existing physical cards etc. The plurality of user accounts, the plurality of digital cards, the plurality of user certificates, and the plurality of image uploads of existing physical cards, among other things, may be stored in a database 104.

The database 104 may store user information, digital cards information, and other related information, as discussed in detail below. The database 104 may be a Structured Query Language (SQL) such as PostgreSQL or MySQL or a not only SQL (NoSQL) database such as MongoDB, or Graph Databases etc.

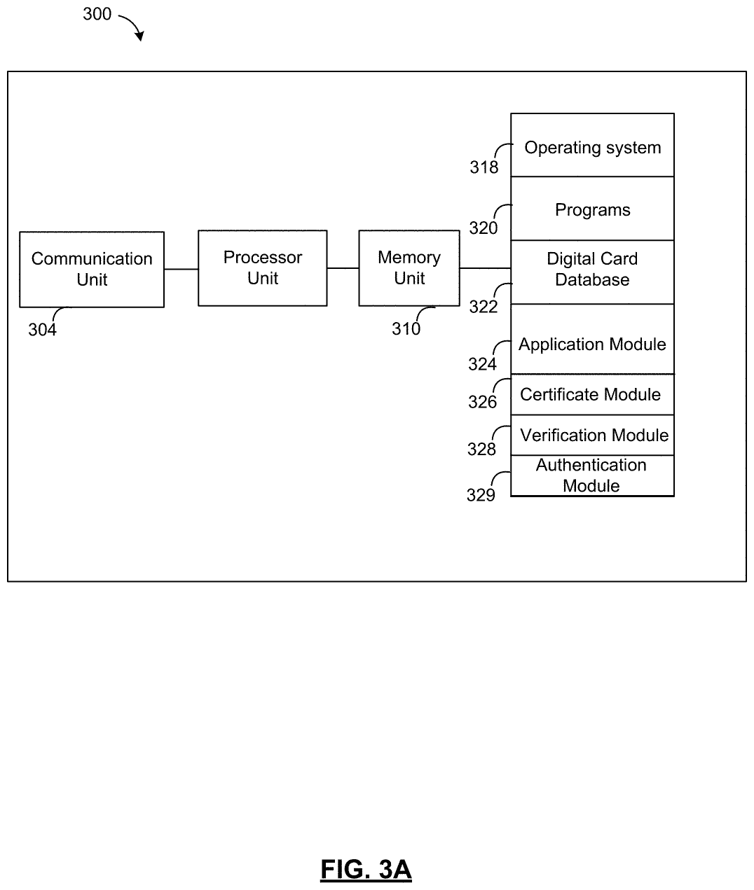

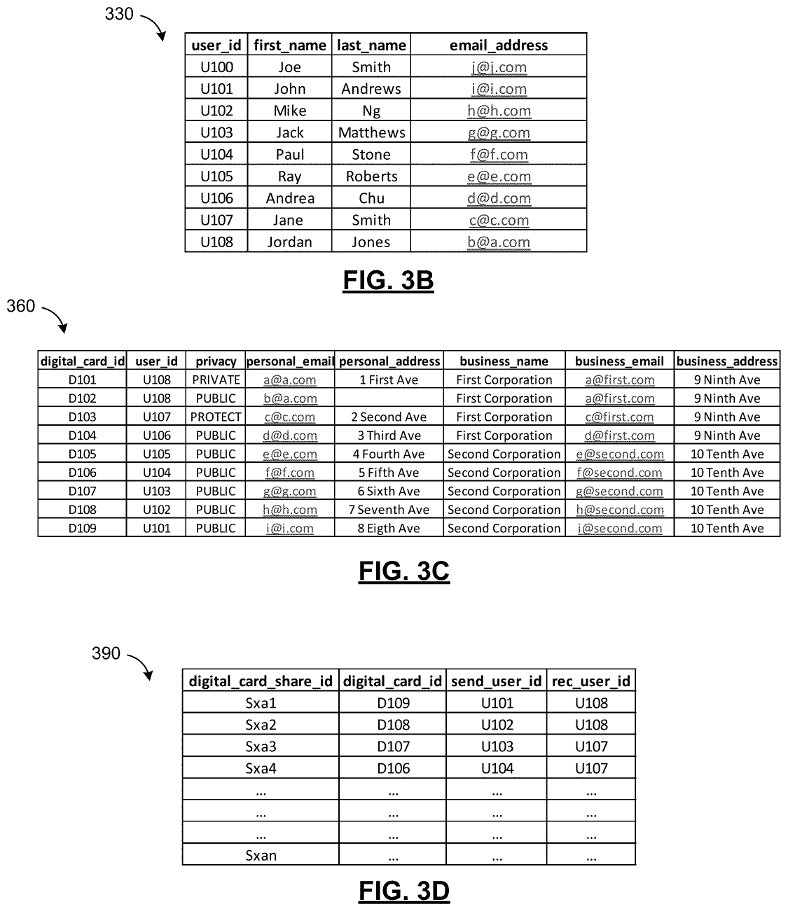

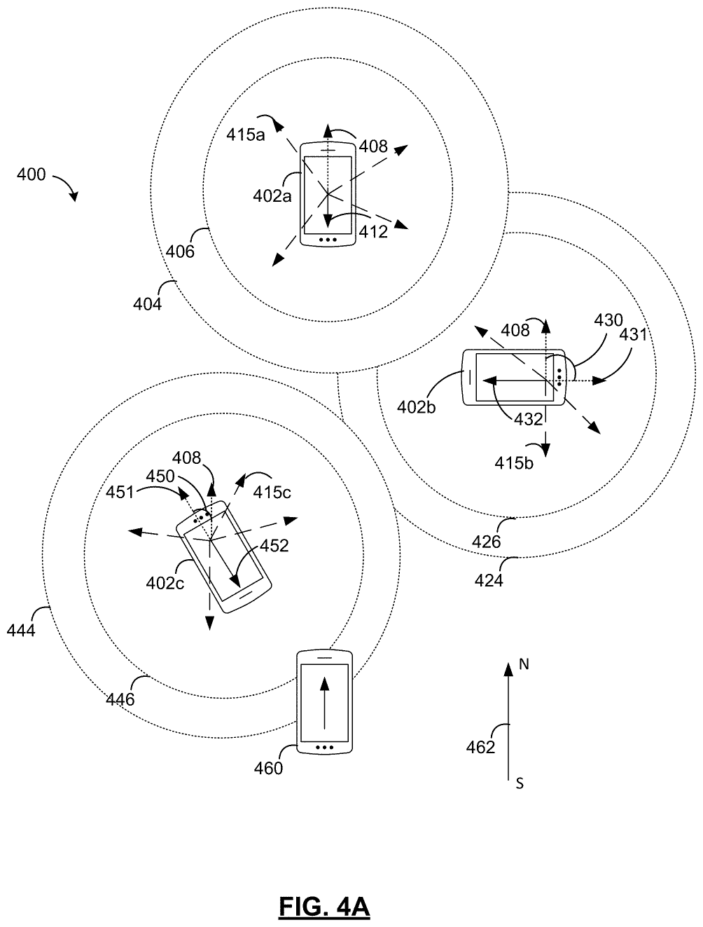

The digital card management system 102 may also include a digital card database, application module, a certification module, a verification module, and an authentication module which may be implemented on a single server, or multiple servers that are communicably linked to each other. This is discussed in detail below with reference to FIG. 3A.

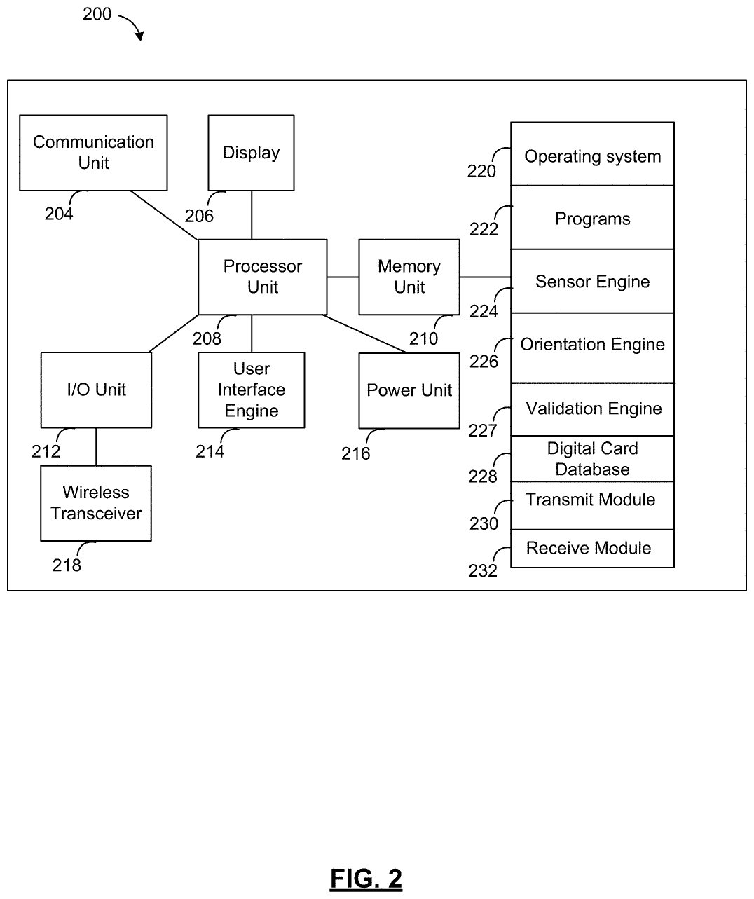

Reference is next made to FIG. 2, which shows a block diagram 200 of a user device, such as a user device 110a from FIG. 1, according to an example. The user device 200 includes a communication unit 204, a processor unit 208, a memory unit 210, I/O unit 212, a user interface engine 214, a power unit 216, and a wireless transceiver 218. The user device 200 may also include an optional display 206,

The processor unit 208 controls the operation of the user device 200. The processor unit 208 can be any suitable processor, controller or digital signal processor that can provide sufficient processing power depending on the configuration, purposes and requirements of the user device 200 as is known by those skilled in the art. For example, the processor unit 208 may be a high performance general processor. In alternative embodiments, the processor unit 208 can include more than one processor with each processor being configured to perform different dedicated tasks. In alternative embodiments, it may be possible to use specialized hardware to provide some of the functions provided by the processor unit 208. For example, the processor unit 208 may include a standard processor, such as an Intel® processor, an ARM® processor or a microcontroller.

The communication unit 204 can include wired or wireless connection capabilities. The communication unit 204 can include a radio that communicates utilizing 4G, LTE, 5G, CDMA, GSM, GPRS or Bluetooth protocol according to standards such as IEEE 802.11a, 802.11b, 802.11g, or 802.11n, etc. The communication unit 204 can be used by the user device 200 to communicate with other devices or computers.

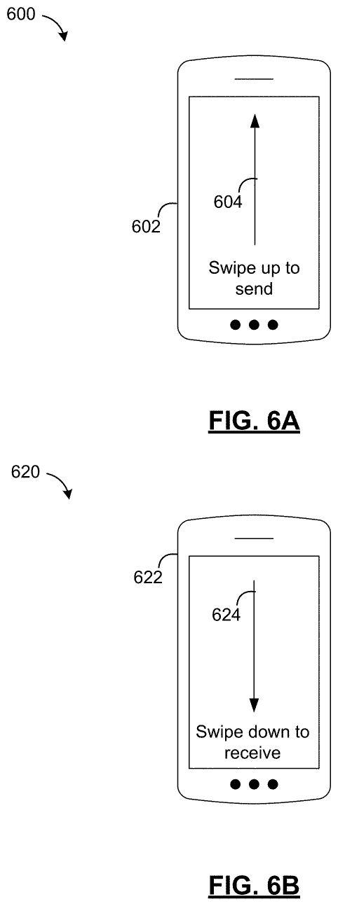

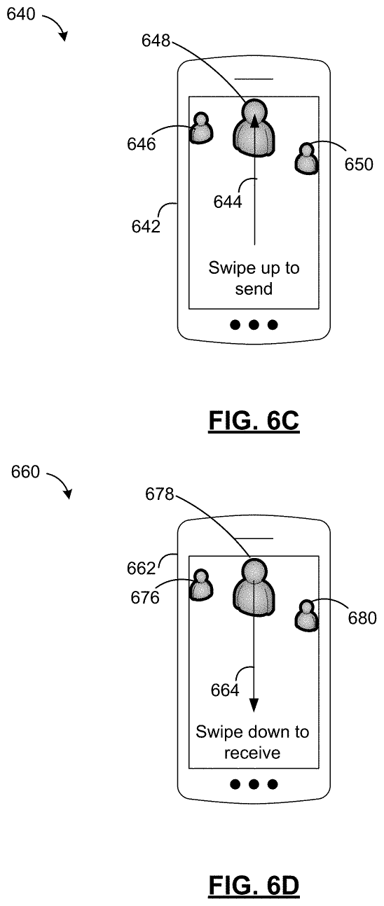

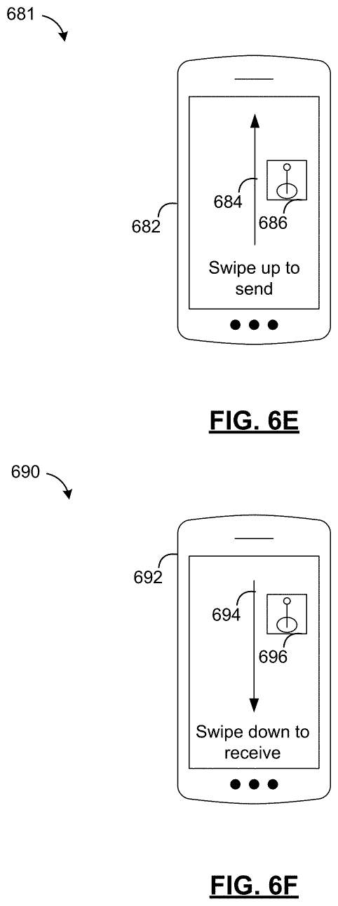

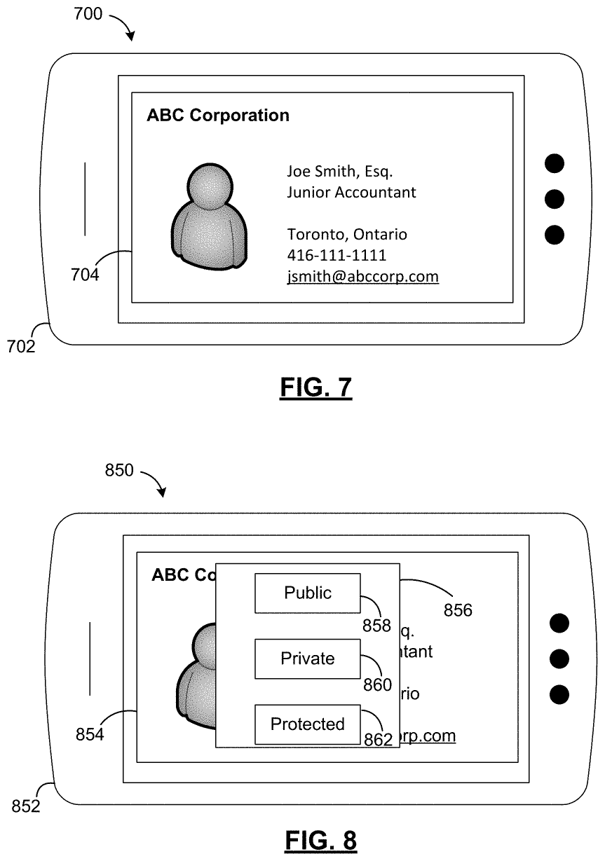

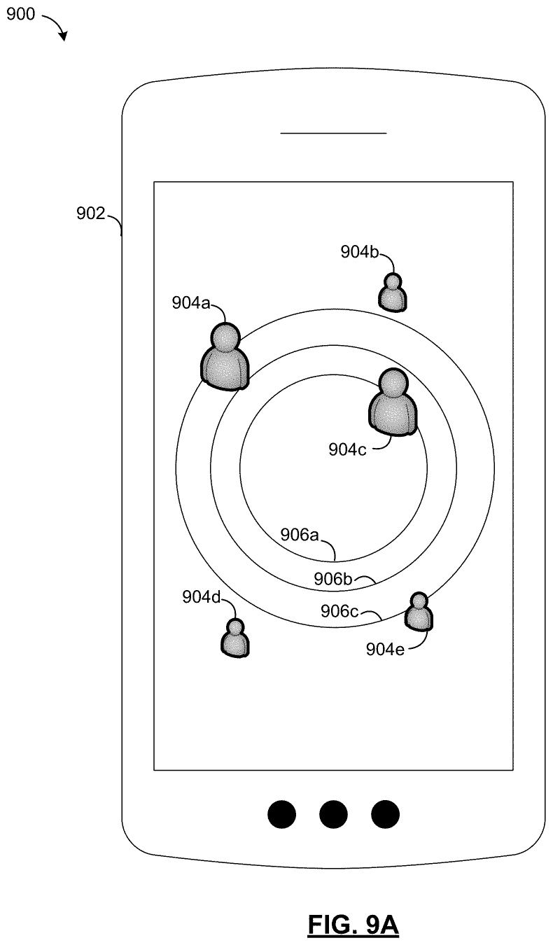

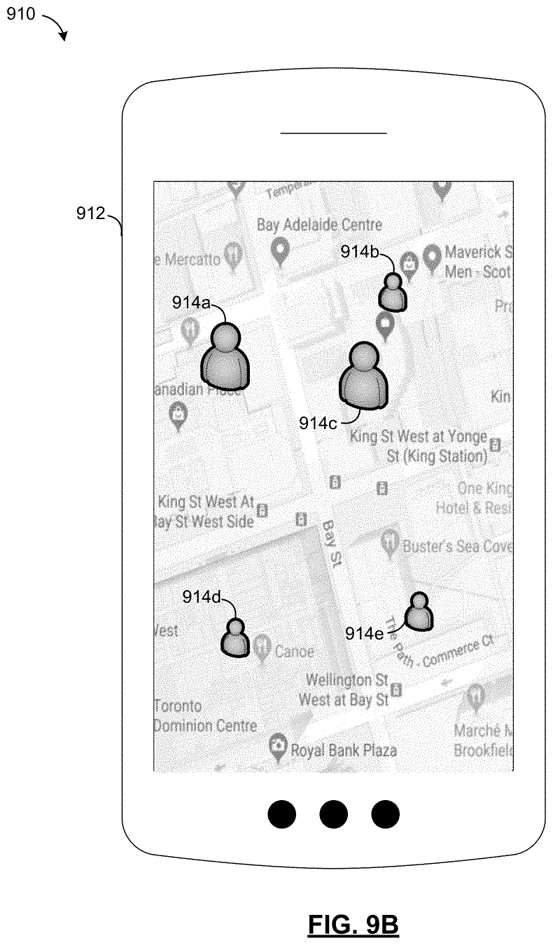

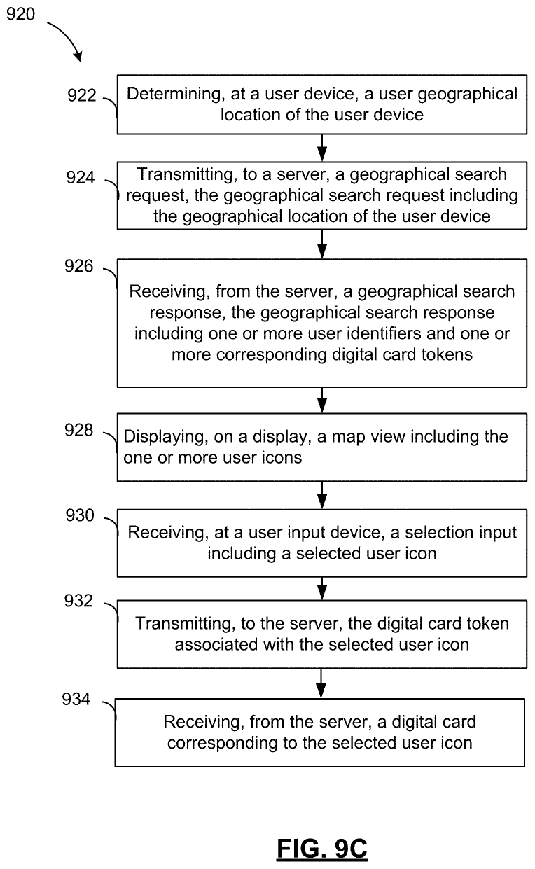

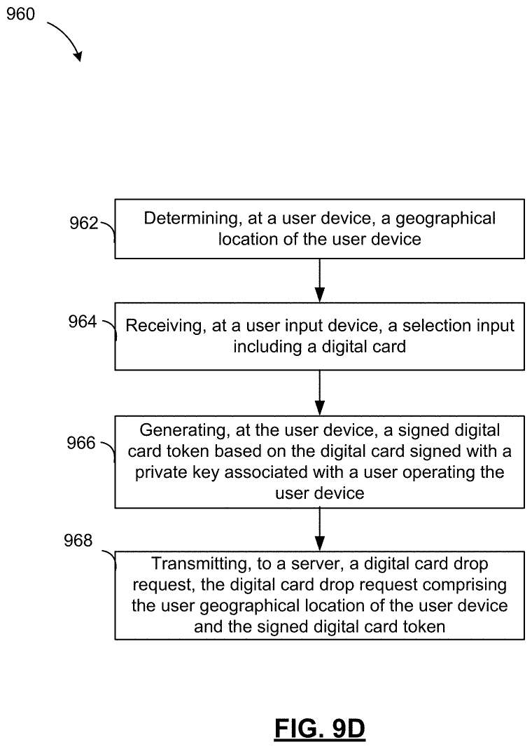

The processor unit 208 can also execute a graphical user interface (GUI) engine 214 that is used to generate various GUIs, some examples of which are shown and described herein, such as interfaces shown in FIG. 6A, FIG. 6B, FIG. 6C, FIG. 6D, FIG. 6E, FIG. 6F, FIG. 7, FIG. 8, FIG. 9A, and FIG. 9B.

The user interface engine 214 is configured to generate interfaces for users to create digital cards, digitize existing physical cards, facilitating the exchange and connection with other user devices to exchange digital cards, and review digital cards received from other user devices, etc. The various interfaces generated by the user interface engine 214 are displayed to the user on display 206.

The display 206 may be an LED or LCD based display, and may be a touch sensitive user input device that supports gestures.

The I/O unit 212 can include at least one of a mouse, a keyboard, a touch screen, a thumbwheel, a track-pad, a track-ball, a card-reader, voice recognition software and the like again depending on the particular implementation of the user device 200. In some cases, some of these components can be integrated with one another.

Communication unit 204 may communicate with the wireless transceiver 218 to transmit and receive information via local network 112. The communication unit 204 may provide communications over the shared wireless media using a network communications protocol such as BT or BLE.

The power unit 216 can be any suitable power source that provides power to the user device 200 such as a power adaptor or a rechargeable battery pack depending on the implementation of the user device 200 as is known by those skilled in the art.

The memory unit 210 comprises software code for implementing an operating system 220, programs 222, sensor engine 224, orientation engine 226, digital card database 228, transmit module 230, and receive module 232.

The memory unit 210 can include RAM, ROM, one or more hard drives, one or more flash drives or some other suitable data storage elements such as disk drives, etc. The memory unit 210 is used to store an operating system 220 and programs 222 as is commonly known by those skilled in the art. For instance, the operating system 220 provides various basic operational processes for the user device 200. For example, the operating system 220 may be a mobile operating system such as Google Android operating system, or Apple iOS operating system, or another operating system.

The programs 222 include various user programs so that a user can interact with the user device 200 to perform various functions such as, but not limited to, viewing and manipulating data as well as sending messages as the case may be.

The sensor engine 224 is coupled to one or more sensors within the user device 200, and is configured to obtain measurements from those sensors. Examples of one or more sensors within the user device 200 include accelerometer, gyroscope, magnetic compass sensor, magnetometer, camera, Global Positioning System (GPS) sensors and Near Field Communication (NFC) sensors, etc. The sensor engine 224 is configured to receive measurements, such as accelerometer data, gyroscope data, magnetometer data, compass data, image data, audio data, video data), GPS data etc.

The orientation engine 226 is configured to use some or all of the sensor data from the sensor engine 224 to determine a device orientation. For example, in some cases, the orientation of the device may be determined based on the compass data obtained using the magnetic compass sensor. In such cases, the device orientation may include a compass angle of the device relative to magnetic north, or a three dimensional vector pointing to the strongest magnetic field (usually the earth's magnetic north pole), or some other representation of the orientation of the user device.

In some other cases, the orientation of the device may be determined based on a combination of compass data and gyroscope data, obtained from the magnetic compass sensor and the gyroscope in the user device 200. In some further cases, the orientation of the device may be determined based on the GPS data and the compass data obtained from the magnetic compass and GPS sensors in the user device 200.

The digital card database 228 may be configured to define and store information, such as user device information, user information (including the user's own digital cards), any received digital cards from other users, user's unique identifier used to identify the user at a digital card management system, such as system 102 of FIG. 1, device's unique identifier used to identify the user device 200 at the digital card management system 102, etc. The digital card database 228 may also store identifiers to digital cards, image data of digital cards, or object-based representations of digital cards, for example, Javascript Object Notation (JSON) or eXtensible Markup Language (XML), etc. The digital card database 228 is also configured to store the public and private keys and certificates associated with the user device 200.

The transmit module 230 is configured to, in collaboration with other components of the user device 200, configure and transmit information signals for transmittal. The transmit module 230 encodes the device's orientation data into an information signal and transmit the information signal. As discussed herein, the transmit module 230 is configured to transmit the information signal when the user has indicated his/her intention to transmit a digital card. In some cases, the transmit module 230 is configured to transmit the information signal when the user has indicated his/her intention to receive a digital card. The information signals are transmitted over a short-distance wireless communication network, such as local network 112 of FIG. 1.

The transmit module 230 is further configured to transmit a signed token to another device in response to a request from the other device. The signed token is a message signed by a private key of the user device 200. As discussed in detail later, the signed token may include a user identifier corresponding to the user operating the user device 200 and a digital card identifier corresponding to the digital card the user device 200 intends to exchange. In some cases, the signed token may also include a device identifier corresponding to the user device 200. The device identifier may be included in addition to, or alternatively to, the user identifier.

The transmit module 230 is configured to transmit a signed token or a corresponding message containing the signed token to a digital card management system, such as system 102 of FIG. 1. The message transmitted to system 102 may include the unique identifier of the user device 200, the unique identifier of the user operating the user device 200, or both.

The transmit module 230 is further configured to transmit a version of the digital card that is to be exchange by the user device 200 with another device. The version transmitted by the transmit module 230 may be a compressed version of the digital card, an object-based representation such as JSON or XML of the digital card, or an encoded version of an image of the digital card.

In various embodiments, the transmit module 232 is further configured to transmit a signed public certificate of the user device 200 to another user device. As discussed in detail below, a signed public certificate may be any public certificate that is generated by a digital card management system, such as the digital card management system 102 of FIG. 1, and is uniquely associated with a user account.

The receive module 232 is configured to receive one or more information signals from one or more other devices. The receive module 232, in collaboration with other components of the user device 200, is configured to extract the orientation information contained within the information signal, the device identifier corresponding to the device transmitting the information signal, and determine the signal strength of the incoming information signal. Based on the signal strength and the orientation information, the user device 200 is configured to determine an ideal transmitting device, as discussed in detail below.

The receive module 232 is further configured to receive a signed token request from another device, where the signed token request includes an indication that the device transmitting the signed token request wishes to receive a digital card from the user device. The signed token request may include the device identifier corresponding to the device transmitting the signed token request, a user identifier corresponding to the user operating the device transmitting the signed token request, or both.

The receive module 232 may be further configured to receive incoming digital card data from the communication unit 204 and wireless transceiver 218. The incoming digital card data may include one or more of a digital card identifier, an object-representation of a digital card (such as JSON or XML data), and one or more images associated with the digital card, etc. The receive module 232 may store the received digital card data in the digital card database 228. The receive module 232 may receive the digital card or a version thereof from another user device 200 or a digital card management system, such as system 102 of FIG. 1, as discussed in detail below.

The receive module 232 may be further configured to receive a signed public certificate from another device. The signed public certificate may be any public certificate that is generated by a digital card management system, such as the digital card management system 102 of FIG. 1, and is uniquely associated with a user account.

The validation engine 227 is configured to validate the signed public certificate received by the user device 200 from another user device. This signed public certificate may be validated using an intermediate certificate that was used to sign the signed public certificate at the digital card management system 102. The intermediate certificate may be packaged with a software application running on the user device 200. In this manner, the validation engine 227 can determine if a device providing the signed public certificate has a validly signed public certificate prior to making a connection with that device.

Reference is next made to FIG. 3A, showing a block diagram 300 of a server of a digital card management system, such as system 102 from FIG. 1, according to an example. The system 300 includes a communication unit 304, processor unit 308 and memory unit 310. While a single server is shown in FIG. 1 and FIG. 3A, it is understood that many different servers may provide individual services, i.e. there may be a separate server providing the digital card database 322 from an application server providing the application module 324. In the embodiment where different servers provide individual services, the different servers are communicably linked to each other.

The communication unit 304 can include wired or wireless connection capabilities. For example, the communication unit 304 can include a radio that communicates utilizing 4G, LTE, 5G, CDMA, GSM, GPRS or Bluetooth protocol according to standards such as IEEE 802.11a, 802.11b, 802.11g, or 802.11n, etc. The communication unit 304 can be used by the digital card management system 300 to communicate with other devices or computers.

The processor unit 308 controls the operation of the digital card management system 300. The processor unit 308 can be any suitable processor, controller or digital signal processor that can provide sufficient processing power depending on the configuration, purposes and requirements of the digital card management system 300 as is known by those skilled in the art. For example, the processor unit 308 may be a high performance general processor. In alternative embodiments, the processor unit 308 can include more than one processor with each processor being configured to perform different dedicated tasks. In alternative embodiments, it may be possible to use specialized hardware to provide some of the functions provided by the processor unit 308.

The memory unit 310 can include RAM, ROM, one or more hard drives, one or more flash drives or some other suitable data storage elements such as disk drives, etc. The memory unit 310 comprises software code for implementing an operating system 318, programs 320, amalgamated digital card database 322, application module 324, certification module 326, verification module 328, and authentication module 329.

The operating system 318 provides various basic operational processes for the operation of the digital card management system 300. For example, the operating system 318 may be a Microsoft® Windows Server® operating system, or a Linux®-based operating system, Unix® or macOS® or another operating system.

The programs 320 comprise program code that, when executed, configures the processor unit 308 to operate in a particular manner to implement various functions and tools for the digital card management system 300.

The amalgamated digital card database 322 is configured to collect the digital card information for all users of the digital card exchange system. The amalgamated digital card database 322 may be on the server 106 (see FIG. 1), or may be in network communication with the server 106 at the digital card management system 102. The amalgamated digital card database 322 may be any database, such as, for example, MySQL®, Postgres®, or MongoDB®.

The amalgamated digital card database 322 is configured to store user account information, such as, for example, unique identifiers associated with users, names of users, email addresses, passwords, telephone numbers and other unique parameters associated with a user, signed public certificates associated with user, and other such account information. The amalgamated digital card database 322 may store identifiers to digital cards, image data, templates of digital cards, or object-based representations of digital cards, for example, in Javascript Object Notation (JSON) or eXtensible Markup Language (XML) formats.

The application module 324 is configured to provide functionality via a web interface accessible via a browser or an API endpoint configured to operate with an application at the user devices, such as a digital card exchange application. The application module may provide functionality to users via the network 108 (see FIG. 1).

The application module may provide functionality such as creation of digital cards, facilitating access to digital cards, updating of digital cards, sharing of digital cards from one user to another, deletion of digital cards, and the like. The application module 324 may be implemented using any web application server, such as NGINX, Apache etc.

The certificate module 326 is configured to provide certificate functionality. The certificate module 326 may implement a public key cryptographic standard (PKCS). The certificate functionality may include issuing a signed public certificate for a user account. The certificate functionality may further include receiving a certificate signing request or a request signal from a user device 200, and issuing a signed public certificate to the user device for future use. The signed public certificate may be additionally stored in the amalgamated digital card database 322 in association within the user account sending the request signal.

The validation module 328 is configured to receive a signed token or a message containing the signed token from a user device over a network. As discussed in detail below, the received signed token is originally encrypted by a transmitting device using the transmitting user's private key and then sent to the receiving device, which forwards the signed token to the validation module 328. The validation module 328 is configured to validate the signed token by decrypting the signed token data using the signed public certificate associated with the transmitting user. Once the signed token is decrypted, an association is made between the digital card intended to be sent to the receiving user and the receiving user's account. The validation module 328 may then send the digital card associated with the signed token to the receiving device.

The authentication module 329 may provide user authentication functionality such as creation of user accounts, facilitating access to user accounts, updating of user accounts, deletion of user accounts, and the like. The authentication module 329 may generate an authentication token upon request from a user device, i.e. at user login to a digital card management system, such as system 102 of FIG. 1. The authentication module 329 may provide an authentication API, where an application running on a user device may request an authentication token, and the authentication module may provide the authentication token in response.

The authentication module may also provide functionality through the authentication API to validate an authentication token. For example, the application module may request that the authentication module verify whether a particular authentication token is valid for a particular user. The authentication token may have a time expiry, for example, the authentication token may only be valid for 30 minutes, but the expiry may be refreshed while a user continues to use the digital card exchange system 100.

Reference is next made to FIG. 3B, there is an example view 330 of a database schema at a digital card management system, such as system 102 of FIG. 1, according to an example. The example view 330 may be a user account table, showing example users of the digital card exchange system 100 as they are stored in the amalgamated database 322 (see FIG. 3A). As shown, in the illustrated embodiment, the fields in the user account table 330 may include a user identifier (user_id), a first name (first_name), a last name (last_name), and an email address (email_address).

In an alternate embodiment, the user account table may include additional information, such as user profile information like the user's phone number, address, public certificate information etc. The user account table may further include a signed public certificate for a user account (not shown), etc. Other user profile attributes may also be tracked, including social media identifiers such as a Facebook® identifier, a Twitter® identifier, etc.

A new record in the user account table may be created when a new user is registered on a digital card management system, such as the digital card management system 102 of FIG. 1. In an alternate embodiment, the first time a user receives a digital card from a sender, a user account may be created automatically for them.

Reference is next made to FIG. 3C, which shows an example view 360 of a database schema at a digital card management system, such as system 102 of FIG. 1, according to another example. The example view 360 may be a digital card table, showing example digital cards associated with the user accounts shown in FIG. 3B. As illustrated, the fields in the digital card table 360 include a digital card identifier (digital_card_id), an associated user identifier (user_id), a privacy status (privacy) that may include PUBLIC, PRIVATE and PROTECTED (privacy status is discussed in more detail at FIG. 7B), at least one personal email address (personal_email_address), at least one personal address (personal_address), at least one business name (business_name), at least one business email address (business_email_address), and at least one business address (business_address).

In an alternate embodiment, the digital card table 360 may further include image data (not shown) associated with a digital card. The digital card table 360 may further include an object-representations of a digital card in XML or JSON. The digital card table 360 may further include other image, video, or audio data (not shown) associated with the display of a digital card.

A user of the digital card management system may create an object representation of a digital card, take an image of an existing physical card (i.e. in a Portable Network Graphics file format), or convert an image of an existing physical card to an object-representation of a digital card. The digital card is associated with the user creating the digital card.

As shown in FIG. 3C, a user, such as user identified by user_id 108, may create more than one digital card, such as digital cards identified by digital_card_ids 101 and 102. The digital_card_id 101 may be set to a ‘private’ status, and digital_card_id 102 may be set to a ‘public’ status by the user associated with user_id 108. In addition, the digital_card_id 101 may contain attributes that are different than digital_card_id 102. For example, the personal email address associated with the two cards may be different. This may be because the user may wish to use the two cards for different applications, such as for professional/academic networking events, digital card associated with digital_card_id 101 may be used but for informal networking events (e.g. Meetups etc.), the digital card associated with digital_card_id 102 may be used. Users may create more than one digital card for a variety of reasons, including digital cards for personal projects, digital cards including personal information, digital cards for individuals with multiple employers, contract employees who rotate employers frequently, etc.

It is noted that the various fields shown in FIG. 3C are examples only. Different fields, or more or less than what is shown in FIG. 3C may be used in different embodiments.

Reference is next made to FIG. 3D, which shows an example view 390 of a database schema at a digital card management system, such as system 102 of FIG. 1, according to another example. The example view 390 may be a digital card sharing table, and may include associations between senders (represented by a user identifier), receivers (represented by a user identifier), and a digital card (represented by a digital card identifier).

When the digital card management system receives a signed token or a digital card request from a user device, a digital card sharing entry may be created including the digital card sharing identifier (digital_card_share_id), a digital card identifier (digital_card_id) associated with the digital card table, the sending user identifier (send_user_id) and the receiving user identifier (rec_user_id) both associated with the user account table.

In some cases, where a digital card is forwarded from a first user to a second user, where the first user is not the original owner of the digital card, but instead received the digital card either directly from the original owner or via intermediate receivers, the entire chain of transfer may be stored in the database 390. In addition, where a sender transfer the digital card to multiple receivers, either simultaneously or over a duration of time, then the database 390 may also reflect all those exchanges.

By way of an example, FIG. 3D shows that a digital card identified by digital_card_id 109 is exchanged by a user identified by send_user_id 101 to a receiver identified by rec_user_id 108. This exchange of digital card is identified by an identifier, i.e. digital_card_share_id.

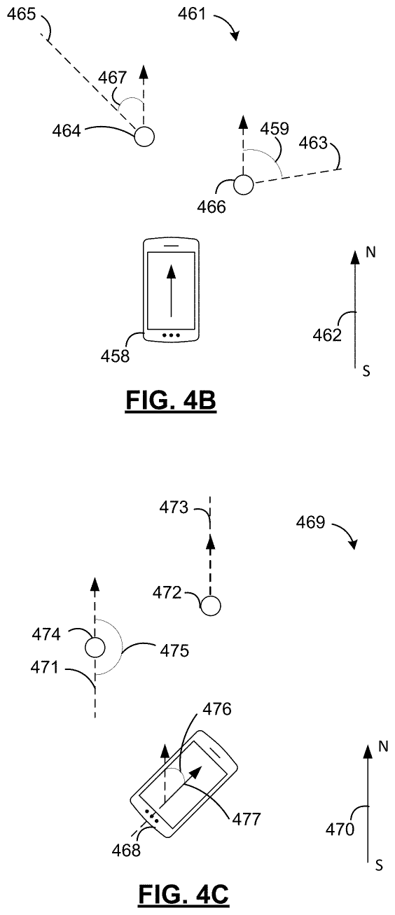

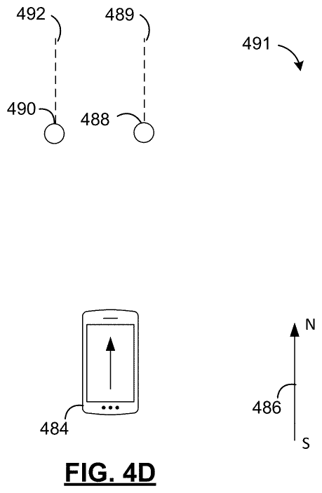

Referring next to FIG. 4A, there is an example view 400 of a plurality of mobile devices, such as mobile devices 110, attempting to exchange digital cards with each other.

In the illustrated scenario, the digital card exchange system, such as system 100 of FIG. 1, comprises three transmitting user devices 402a, 402b, and 402c, and one receiving device 460. It is understood that there may be many more sending and receiving devices than are shown in this example.

The transmitting user devices are attempting to transmit their digital cards to the receiving device, and the receiving device 460 is attempting to identify the intended sender whose digital card the receiving device 460 wishes to accept. The various transmitting and receiving devices may be at a venue, such as at a boardroom or a meeting hall for a networking event, where multiple devices may be attempting to send and receiving digital cards with each other. The challenge faced by the receiving device 460 is to identify the intended sender and only receive the digital card from the corresponding transmitting device, and not from other transmitting devices. The process of such a digital card exchange is discussed in detail next.

A compass legend 462 (also known as a compass “rose”) is shown indicating generally the direction of north and south relative to the user devices.

In the illustrated embodiment, each of the transmitting devices, wishing to send digital cards, transmit one or more information signals containing encoded data. For example, the transmitting device 402a is configured to transmit one or more information signal 415a, the transmitting device 402b is configured to transmit information signal 415b and the transmitting device 402c is configured to transmit information signal 415c.

Each of the various transmitting devices 402a, 402b, 402c transmit information signals in a continuing series, i.e. one after another, over a duration of time. In the illustrated embodiment, the information signals transmitted by the various transmitting devices radiate in all directions with the same intensity.

In various embodiments disclosed herein, the various information signals 415a, 415b, 415c are Bluetooth or BLE advertising packets that are detectable by BLE compatible devices, such as receiving device 460.

The encoded data contained in each information signal contains user's unique identifier and orientation data of the corresponding transmitting device. The orientation data indicates the direction in which the transmitting device is oriented while transmitting the information signals. In the various embodiments illustrated herein, the orientation data of a mobile device is gathered based on one or more sensors at the user device. For example, the orientation of the mobile device is determined based on compass data obtained from the device's magnetic compass.

Referring to FIG. 4A, the first transmitting device 402a having an example unique user identifier of “00000001” is shown to have a compass heading 412 at an angle 410 relative to north direction, shown by arrow (“north directional arrow”) 408. Similarly, the second transmitting device 402b having an example unique user identifier of “000000002” is shown to have a compass heading 432 relative to north directional arrow 408, and the third transmitting device 402c having an example unique user identifier of “000000003” is shown to have a compass heading 452 relative to north directional arrow 408.

In various embodiments, the information signal transmitted by each of the first, the second, and the third transmitting devices 402 includes at least their unique user identifier for the user operating the respective device and the orientation data for the device. In some other embodiments, the information signal may include a unique device identifier in addition to (or instead of) the unique user identifier. In another embodiment, the information signal may include a unique digital card identifier in addition to (or instead of) the unique user identifier.

In the various embodiments herein, another type of data that is obtained from the information signals, such as signals 415a, 415b, 415c, is the signal strength associated with the information signals. The receiving device 460 is configured to determine the signal strengths associated with the incoming information signals 415a, 415b, 415c transmitted by various transmitting devices. The signal strength provides an indication of an approximate distance between the corresponding transmitting device and the receiving device 460. For example, the greater the distance between the transmitting device and the receiving device 460, the lower the signal strength of the information signal transmitted from the transmitting device, as perceived by the receiving device 460.

The signal strengths of the information signals may be measured in dBm, which is the power ratio in decibels (dB) of the measured power referenced to one milliwatt. In some other cases, some other measurement unit for signal strength measurement, based on some predefined protocols, may be used.

In most cases, the signal strength of an information signal is affected by various objects, such as human bodies, user devices, furniture, and other objects existing in the way of the information signals. Such objects may absorb or reflect the information signals, affecting their signal strengths. Accordingly, the signal strength of an information signal, as determined by the receiving device 460, may vary slightly.

By way of an example, the signal strength of the information signal 415a transmitted by device 402a, as perceived by the receiving device 460, is shown to be between the range of signal strength indicator 406 (low end) and signal strength indicator 404 (high end) depending on the obstructions along the way. Similarly, the perceived signal strength of the information signal 415b transmitted by device 402b is shown to be between the range of signal strength indicator 426 (low end) and signal strength indicator 424 (high end). The perceived signal strength of the information signal 415c transmitted by device 402c is shown to be between the range of signal strength indicator 446 (low end) and signal strength indicator 444 (high end).

In various embodiments, the receiving device 460 receives the information signals, such as signals 415a, 415b, 415c, from various transmitting devices 402a, 402b, 402c, and processes those information signals to determine the orientation of that transmitting device and distance from the transmitting device that is transmitting the corresponding information signal. As discussed above, the device's orientation is determined based on the encoded orientation data in the incoming information signal, and the distance is determined based on the signal strength associated with the incoming information signal. The receiving device 460 uses the orientation and distance information to determine the intended transmitting device from which the digital card should be accepted, referred to herein as ‘ideal transmitting device’. Further, the receiving device 460 receives the unique user identifier in each information signal, where the unique user identifier identifies the user at each respective device.

In one embodiment, the inverse of orientation data contained in the information signal is used to determine the orientation of the transmitting device. For example, if the information signal includes orientation information as an angle, measured using the device's magnetic compass, the receiving device may be configured to determine the inverse angle of the angle contained in the information signal. In the illustrated embodiment, the first transmitting device 402a is shown to have an inverse compass heading that aligns with north direction, as shown using north directional arrow 408. Similarly, the second transmitting device 402b is shown to have an inverse compass heading 431 that is at an angle 430 relative to north directional arrow 408. The third transmitting device 402c is shown to have an inverse compass heading 451 that is at an angle 450 relative to north directional arrow 408.

In this embodiment, the receiving device 460 may process the encoded data contained in the information signal to determine the inverse angle or compass heading. The receiving device 460 then uses the inverse compass heading information to determine the orientation of the corresponding transmitting device in relation to itself.

In various embodiments, the various devices are required to select their intention before commencing the transmitting or receiving of information signals. For example, one or more user devices, such as user devices 110 of FIG. 1, may select their intention to ‘transmit’ before transmitting the digital card, and accordingly the information signals. The intention of the transmitting device is then encoded in the information signal along with other encoded data. In the illustrated example of FIG. 4A, the devices 402a, 402b, 402c select their intention to ‘transmit’ before transmitting the information signals, and the corresponding information signals 415a, 415b, 415c includes the ‘transmit’ intention as encoded data.

Similarly, the user devices 110 wishing to receive the digital cards may select their intention to ‘receive’ before receiving the various incoming information signals. The receiving device, such as receiving device 460, explores the incoming information signals to ensure that it processes only those information signals that contain a ‘transmit’ intention therein.

The user devices may select their intention by one of many ways, such as swiping, pressing a button, or otherwise interacting with an application on the transmitting or receiving devices. The intention to send a digital card by a user at a transmitting device 402a, 402b, 402c may also include an indication of which digital card the user wishes to exchange.

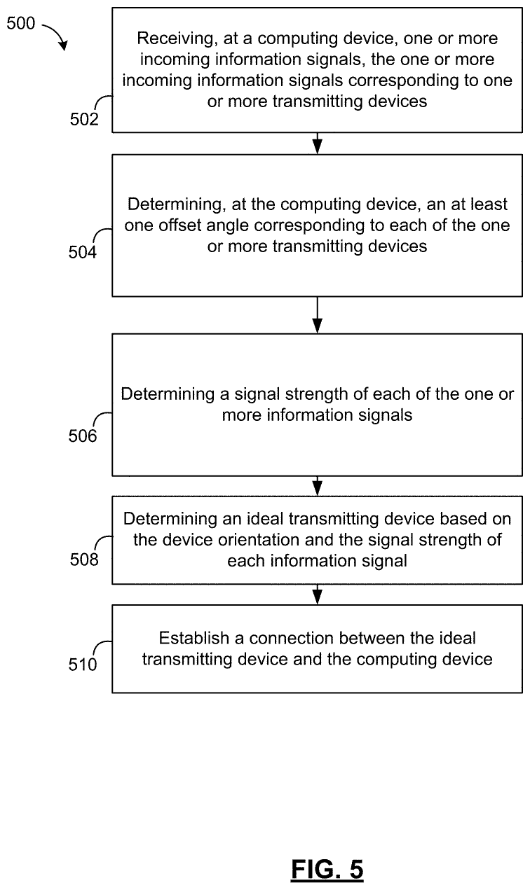

Reference is next to FIG. 5, which shows a process flow diagram 500 for exchanging digital cards according to one example. When users of transmitting devices, such as transmitting devices 402a, 402b, 402c of FIG. 4A, and receiving devices, such as receiving device 460 of FIG. 4A, launch the exchange application on their devices, an initial information signal is transmitted using the shared wireless medium to announce their presence to other devices. User devices may enter a receiving mode or a transmitting mode based on user input, and the initial information signal may include that intention as encoded data. In transmitting mode, each of the transmitting devices, such as devices 402a, 402b, 402c, continue to transmit information signals 115a, 115b, 115c using a shared wireless medium.

The receiving user device 460 may also transmit a broadcast information signal using a shared wireless medium when entering the receiving mode to announce to other devices that it is entering the receiving state. In receiving mode, the receiving device 460 may continue to broadcast information signals using the shared wireless medium identifying its state.

The method 500 of FIG. 5 may be referred to as “device discovery” process.

At 502, a computing device, such as the receiving device 460 of FIG. 4A, receives one or more incoming information signals transmitted by one or more transmitting devices. The incoming information signals have a device orientation information encoded therein. Each information signal also has a corresponding signal strength, as perceived by the computing device. The transmitting devices and the computing device may use a shared communications protocol, for example BT or BLE and a shared wireless medium to transmit and receive information signals from one another.

At 504, the computing device processes the one or more incoming information signals and determines a device orientation parameter corresponding to processed information signals. The computing device may consider each of the one or more transmitting devices corresponding to the one or more incoming information signals as a candidate device. The device orientation parameter is an indicator of the orientation of the device transmitting the information signal processed by the computing device.

In some cases, the computing device may determine the device orientation parameter based on the sensor information included within the information signal. As discussed above, the sensor may be the device's magnetic compass, and the device's orientation parameter may be determined based on the compass angle information included in the information signal.

In some other cases, the computing device may determine the device orientation parameter based on the inverse of the compass angle information included within the information signal.

In some further cases, the computing device may determine the device orientation parameter based on the inverse of the compass angle information included within the information signal and the orientation of the computing device receiving the information signals. For example, in such cases, the computing device may determine an offset angle between the inverse compass angle (determined from the information signal received from a transmitting device) and the compass data associated with the computing device. A low offset angle may signify that the transmitting user device is facing towards the receiving computing device, whereas a higher offset angle may signify that the transmitting device is facing away from the receiving computing device.

At 506, the one or more information signals are further processed by the computing device and signal strengths of the one or more information signals are determined. The signal strength may be expressed in dBm. For example, the signal strength of a signal may be −80 dBm.

In some cases, the computing device may filter out some information signals based on a predetermined signal strength threshold. For example, in some cases, the computing device may filter out all information signals who signal strengths are less than −55 dBm. The threshold value of −55 dBm is used as an example only, and in other cases, other threshold values may be used.

At 508, the computing device determines an ideal transmitting device from the plurality of candidate transmitting devices based on the device orientation parameter and the signal strength corresponding to each information signal.

In some cases, the computing device may be configured to determine the ideal transmitting device based on a set of pre-determined thresholds for device orientation parameters and signal strengths. For example, the computing device may group the signal strengths of the incoming information signals into different groups based on certain pre-determined thresholds. In one example, the computing device may be configured to filter the information signals based on a first pre-determined threshold (e.g. −35 dBm), where all the information signals with signal strengths greater than the first pre-determined threshold are grouped in a first group, and all the information signals with signal strengths lower than the first pre-determined threshold are grouped in a second group and so on.

Next, the computing device may sort the information signals within each group based on the pre-determined thresholds for device orientation parameters. In one example, the computing device applies pre-determined thresholds associated with offset angles and sort the information signals based on the offset angles. For example, the computing device may apply a first pre-determined threshold of +/−35 degrees, and group the information signals into different groups based on whether or not the offset angles are within or outside the range of +/−35 degrees. The information signals in the first group (i.e. with high signal strengths) and with an offset angle of less than +/−35 degrees will be ranked higher than the information signals in the same group with an offset angle of more than +/−35 degrees.

In another example, the computing device may apply more pre-determined thresholds and sort the information signals accordingly. For example, the computing device may implement a second pre-determined threshold of +/−65 degrees and a third pre-determined threshold of +/−90 degrees. In this example, the information signals with offset angles within the second pre-determined threshold will be ranked higher than the offset angles between the second and third pre-determined thresholds.

In some other cases, the computing device may apply the device orientation thresholds before the signal strength thresholds, and accordingly rank the information signals. In such cases, the computing device may determine the ideal transmitting device by looking to the lowest offset angle group (based, for example, on the first pre-determined threshold) for the information signal with the greatest signal strength, and then repeating for the next highest angle group (based, for example, on the second pre-determined threshold), and so on.

In some other embodiments, the determination of the ideal transmitting device may involve a weighted linear combination of the orientation information and the signal strengths. For example, the method may determine a ranking score (R) using equation 1 below for each received information signal having a signal strength (S), a signal strength weight (a), an offset angle (Θ), and an offset angle weight (b) using equation 1. After determining a ranking score for each information signal, the information signal having the highest score may be selected to establish the connection.

R=aS+b(180−|e|) Eq. (1)

In some cases, the ranking of received information signals may be displayed to the user on the display of the receiving device 460. The ranking may be displayed in a list format, with the highest ranked candidate transmitting device appearing higher than the lower ranked candidate transmitting devices. In another example, the highest ranking candidate user at a transmitting device may have the largest icon, and may be presented prominently to the user. In another example, the ranking may be displayed by way of icons, with each icon representing a candidate transmitting device. In this example, the size of the icons represents the ranking of the candidate transmitting devices, where a larger sized icon indicates a higher ranked candidate transmitting device than a lower sized icon. In this embodiment, the user operating the receiving device 460 has the capability to select the transmitting device from which it intends to receive a digital card or cards.

In some other embodiments, the user operating the transmitting device 460 is given a pre-determined duration of time within which to make a selection of the transmitting device. If no selection is made within the pre-determined duration of time, then the receiving device 460 is configured to receive the highest ranked candidate transmitting device.

At 510, a connection is established between the ideal transmitting device and the computing device and the process of digital card exchange from the ideal transmitting device to the receiving device commences.

In some cases, the method 500 of FIG. 5 may be applied by the transmitting devices in addition to the receiving devices, so that the transmitting devices may determine an ideal receiving device to connect to. In one example, the ranking of the receiving devices may be displayed to the user at the transmitting device, as above, allowing the user operating the transmitting device to select the intended receiving device.

Referring next to FIGS. 4B to 4D, there are shown representative examples of a plurality of transmitting devices and a receiving device, and the ranking of the transmitting devices based on the process flow of FIG. 5.

FIG. 4B shows a representative example view 461 of a plurality of mobile devices attempting to participate in a digital card exchange. This example 461 includes a first transmitting device 464, a second transmitting device 466, a receiving device 458, and a compass legend 462.

In the illustrated example, the first transmitting device 464 has an orientation in the south-east direction, the second transmitting device 466 has an orientation in the south-west direction, and the receiving device 458 has an orientation in the north direction.

The information signals transmitted by each of the first transmitting device 464 and the second transmitting device 466 include the orientation information as encoded data within the respective information signals. For example, the information signals transmitted by the first transmitting device 464 includes orientation data, e.g. from device's magnetic compass, indicating the device's orientation in the south-east direction. Similarly, the information signals transmitted by the second transmitting device 466 includes orientation data, e.g. from device's magnetic compass, indicating the device's orientation in the south-west direction. In most cases, the orientation data is expressed as an angle in relation to north.

The information signals, once received by the receiving device 458, are processed to determine the orientation of the corresponding transmitting device. In this example, the receiving device 458, upon receiving the information signals from the first transmitting device 464, determines the inverse of the orientation angle contained in the information signal. As shown, the first transmitting device 464 has a first inverse direction 465. The first inverse direction 465 is at a first offset angle 467 from north.

Similarly, the receiving device 458, upon receiving the information signals from the second transmitting device 466, determines the inverse of the orientation angle contained in the information signal. As shown, the second transmitting device 466 has a second inverse direction 463, which is at a second offset angle 459 from north.

The receiving device 458 further processes the information signals to determine an offset angle of orientation for the information signals with respect to its own orientation. For example, the receiving device 458 determines the offset angle for the information signals from the first transmitting device 464 to be at an angle 467 with respect to the orientation of the receiving device 458, which aligns with the north direction. Similarly, the receiving device 458 determines that the offset angle for the information signals from the second transmitting device 466 is angle 467 with respect to the orientation of the receiving device 458, which aligns with the north direction.

For this example, the first transmitting device has a signal strength of −50 dBm and an offset angle 467 of −60 degrees, and the second transmitting device has a signal strength of −45 dBm and an offset angle 459 of 80 degrees.

In this example, to determine the ideal transmitting device, the receiving device 458 may apply a first threshold to filter out transmitting devices whose information signals have a signal strength, as perceived by the receiving device, lower than the first threshold. The first threshold is −55 dBm for the purposes of this example. In this example, both the first and the second transmitting devices 464, 466 have signal strengths higher than the first threshold.

Next, the receiving device filters the transmitting devices based on pre-determined orientation thresholds. It is assumed that the pre-determined orientation thresholds include a first threshold of +/−35 degrees, a second threshold of +/−60 degrees and a third threshold of +/−90 degrees. Accordingly, the receiving device identifies the transmitting devices based on the three pre-determined thresholds. In this example, no transmitting devices are in the +/−35 degree threshold, the first transmitting device is in the +/−65 degree threshold, and the second transmitting device is in the +/−90 degree threshold.

In this example, since the first transmitting device 464 is within the +/−65 degree threshold, it is ranked higher than the second transmitting device 466 that is within the +/−90 degree threshold. Accordingly, the first transmitting device 464 is selected as the ideal transmitting device by the receiving device 458.

FIG. 4C shows another example view 469 of a plurality of mobile devices attempting to participate in a digital card exchange. This example 469 includes a first transmitting device 474, a second transmitting device 472, a receiving device 468, and a compass legend 470.

FIG. 4C generally shows the situation where the first transmitting device 474 is faced away from the receiving device and the second transmitting device 472 is faced towards the receiving device.

Based on the receiving information signals, the receiving device 468 determines that the first transmitting device 474 corresponds to a first inverse direction 471. The first inverse direction 471 is at a first offset angle 475 from north. Similarly, the receiving device 468 determines that the second transmitting device 472 corresponds to a second inverse direction 473, which generally extends northward. In this example, the receiving device 468 has a device orientation direction 477, which is at an angle 476 from north.

For this example, the first transmitting device has a signal strength of −40 dBm and an offset angle of ‘180—angle 476’ degrees with respect to the receiving device 486. The second transmitting device has a signal strength of −50 dBm and an offset angle of ‘—(angle 476)’ degrees. Assuming that angle 476 equals 45 degrees, the offset angle corresponding to the first transmitting device is 135 degrees, and the offset angle corresponding to the second transmitting device is −45 degrees.

To determine the ideal transmitting device, the receiving device 468 may apply a threshold to filter out transmitting devices with low signal strengths (for example, the threshold of −55 dBm may be applied). In this example, both the first and the second transmitting devices 474, 472 have signal strengths higher than the −55 dBm threshold.

The receiving device then ranks the transmitting devices 474, 472 based on the offset angles and the pre-determined orientation thresholds. It is assumed that the pre-determined orientation thresholds include a first threshold of +/−35 degrees, a second threshold of +/−60 degrees and a third threshold of +/−90 degrees.

Accordingly, in this example, the receiving device 468 determines that the second transmitting device is in the +/−65 degree group, and no device is in the +/−35 degree or +/−90 degree group. Accordingly, the first transmitting device is filtered out by the receiving device since the offset angle of 135 degrees is greater than +/−90 degree threshold.

In this example, the receiving device 468 ranks the second transmitted device 472 higher than the first transmitting device 474, and considers it the ideal transmitting device.

FIG. 4D shows another example view 491 of a plurality of mobile devices attempting to exchange digital cards with each other. This example 491 includes first transmitting device 490, a second transmitting device 488, a receiving device 484, and a compass legend 486.

FIG. 4D generally shows the situation where the first and second transmitting devices are both facing the receiving device at generally the same angle.

Based on the incoming information signals, the receiving device 484 determines that the first transmitting device 490 is associated with a first inverse direction 492, which is generally extending northward. Similarly, based on the incoming information signals, the receiving device 484 determines that the second transmitting device 488 is associated with a second inverse direction 489, which also generally extends northward. Receiving device 484 has a device orientation generally north.

For this example, first transmitting device has a signal strength of −50 dBm and an offset angle of 0 degrees and second transmitting device has a signal strength of −50 dBm and an offset angle of 0 degrees. To determine the ideal transmitting device, the receiving device 484 may apply a threshold to filter out transmitting devices with low signal strength, in this example the threshold is −55 dB. The receiving device then determines the offset angles of both the first and the second transmitting devices 490, 488.

In this example, the receiving device 484 determines that the offset angles for both first and the second transmitting devices 490, 488 is which the first threshold of +/−35 degrees. The receiving device 484 then concludes that both the first and the second transmitting devices 490, 488 have signal strengths higher than the signal strength threshold of −55 dBm, and are within the first orientation threshold.

Example 491 generally represents a tie in the ranking between the first and second transmitting devices 490, 488, and in such a situation the receiving device 484 may display both the transmitting devices to the user operating the receiving device 484 prompting the user to select the ideal transmitting device from the displayed choices.

Reference is next made to FIG. 6A, which illustrates an examples of a user device interface 600 for sending a digital card. The user operating the transmitting device 602 launches the digital card exchange application on his/her transmitting device 602. The digital card exchange application allows the transmitting device 602 to transmit information signals in a shared wireless medium, according to various embodiments discussed in this application.

The user operating the transmitting device 602 may press a button or otherwise interact with the application to indicate an intent to transmit a digital card. In the illustrated embodiment, the user operating the transmitting device 602 may use a gesture, such as a swipe up gesture 604, to select the intent to transmit a digital card, and accordingly enter a transmitting mode. The swipe up gesture 604, once executed, may trigger the transmitting device 602 to transmit information signals carrying the intent of the transmitting device 602 to transmit a digital card, and encoded data identifying the orientation information of the transmitting device 602.

Referring now to FIG. 6B, there is shown an example of a user device interface 620 for receiving a digital card. The user at receiving device 622 launches the digital card exchange application. The digital card exchange application allows the receiving device 622 to receive information signals from a shared wireless medium, according to various embodiments discussed in this application.

The user operating the receiving device 622 may press a button or otherwise interact with the digital card exchange application to indicate an intent to receive a digital card. In the illustrated embodiment, the user operating the receiving device 622 may use a gesture, such as a swipe down gesture 624, to select the intent to receive a digital card, and accordingly enter a receiving mode.

The swipe down gesture 624, once executed, may trigger the receiving device 622 to transmit broadcast signals identifying the intention of the receiving device 622 to receive information signals from transmitting devices. In addition, the swipe down gesture 624, once executed, may trigger the receiving device 622 to begin receiving information signals from surrounding transmitting devices.

Referring now to FIG. 6C, there is shown an example of a user device interface 640 for sending a digital card. In user device interface 640, multiple receiving devices are displayed represented by user icons 646, 648, and 650. Each of the receiving devices or the corresponding users displayed on the interface 640 have expressed their intent to receive a digital card. The size of the user icons may be determined based on the ranking of the receiving devices, where the larger sized icon represents a highest ranked receiving device, and a smaller sized icon represents a lower ranked receiving device. The receiving devices may be ranked based on the process flow discussed in FIG. 5.

The user device interface 640 allows the user operating the transmitting device 642 to select the intended receiving device to whom the digital card is intended to be sent. As shown, the user operating the transmitting device 642 may use a swipe up gesture 644 to select the intended receiving device. Once the intended receiving device is selected, the transmitting device 642 begins to transmit information signals in the direction of the intended receiving device. The information signals include the orientation data information. In some cases, the information signals may also include the intent to transmit information. In addition, the information signals may include the device identifier, as well as the digital card identifier identifying the digital card the transmitting devices wishes to exchange with the receiving device.

Reference is next made to FIG. 6D, which illustrates a user device interface 660 for receiving a digital card. In user device interface 660, multiple transmitting devices are displayed represented by user icons 676, 678, and 680. The size of the user icon may be determined based on the ranking of the transmitting devices, as determined by the receiving device based on the various embodiments disclosed herein.

The interface 660 may allow the user operating the receiving device 662 to select the intended transmitting device by using a swipe down gesture 664, as shown in FIG. 6D. Tapping, pressing a button, or other ways of selecting the intended transmitting device may also be implemented in the user interface 660. The swipe down gesture 664, once executed, establishes a connection between the receiving device 662 and the intended transmitting device.

Referring now to FIG. 6E there is shown a user device interface 681 for leaving or dropping-off a digital card at a location. By ‘drop-off’, it is meant that a user(s) can designate one or more of his/her digital card(s) as available for sharing or receiving by another user if the geographical location of the designated card(s) overlap with the geographical location of the other user.

In user device interface 681, the digital card exchange application may provide a location indicia 686. The user entering into the transmit mode may, instead of transmitting a digital card to a receiving user device, leave a digital card at a location. The location identified by the indicia 686 may be determined based on the geographical location (for example, the latitude and longitude provided by the device GPS) of the transmitting user device 682. The method for leaving a digital card at a geographical location is described in further detail in FIG. 9D. Leaving a digital card at a location may be accomplished by a user tapping, or otherwise interacting with the location indicia 686. As shown, the user operating the transmitting device 682 may leave a digital card at a location by using a swipe up gesture 684 to leave his/her digital card at a location.

The digital card left at the location identified by indicia 686 may be made available to other users generally in the same GPS location (see FIG. 9B). For example, at a networking event, a user may wish to leave their card behind so that any users who wish to receive the user's digital card can do so at a later time. The digital card may be associated with a location for a configurable length of time, for example one day or one week etc.

Responding to the user selection of the location indicia 686, the transmitting user device 682 may send a request to a server, such as digital card management system 102 of FIG. 1, identifying the GPS coordinates of the location and a digital card identifier. The digital card left by a user may require that the digital card has a public visibility (as discussed in FIG. 7B below). A user dropping a digital card at a location may be required to have a digital card with public visibility.

Referring now to FIG. 6F, there is shown a user device interface 690 for ‘picking up’ a digital card at a location. In user device interface 690, the digital card exchange application may provide a location indicia 696. When an application enters a receiving mode, it may connect to a server, such as digital card management system 102 of FIG. 1, and query for digital cards that have been left at a geographical location associated with the receiving device. By ‘pick-up’, it is meant a digital card(s) can be accepted by a user device if the geographical location of the user device overlaps with the geographical location where another user(s) has indicated his/her digital card(s) to be available for exchange or sharing (referred to herein as ‘drop-off’).

If there are digital cards available for pickup at or around the receiving device's location, the receiving device may be capable of picking the digital card from the location. The method for picking up a digital card at a geographical location is described in further detail in FIG. 9C.

The location identified by the indicia 696 may be determined based on the geographical location of the receiving user device 692. The geographical location may be determined based on a GPS sensor in the receiving user device 692. In some other cases, other sensors may be used to determine the geographical location of the receiving user device 692. Picking up a digital card at a location may be accomplished by a user tapping, or otherwise interacting with the location indicia 696. For example, as shown, the user operating the receiving device 692 may pick up an available card or cards from a location by using the swipe down gesture 694. Picking up a card using location indicia 696 may automatically add the digital card to the user's address book.

The digital card left at the location identified by indicia 696 may be made available to other users generally in the same geographical location. If multiple digital cards are left at the same location, the user may be prompted to select which digital card the user wishes to pick up. For example, at a networking event a user may have missed an opportunity to connect with another user, and may locate their digital card if it is left at the location. The digital card may be associated with a location for a configurable length of time, for example one day or one week etc.

In most cases, the selection of a digital card or cards for pickup at a location 696 by the receiving device triggers a request to a server, such as the digital card management system 102 of FIG. 1. The request to the server includes a digital card identifier or identifiers identifying the digital card or cards the receiving device wishes to pickup from a location. The server transmits the digital card or cards associated with the received identifier or identifiers to the receiving device.

Reference is next made to FIG. 7, which illustrates an example of a user device interface 700 for displaying a digital card. The digital card 704 may be displayed on a display device of device 702, and may include information such as a company logo, a company name, a name, title, position, address, telephone number, email address, etc. The digital card 704 may have multiple sides including additional information such as marketing or promotional material. The multiple sides may be accessed by a user swiping across the digital card 704 when it is displayed. The digital card 704 may include images, animations, video content, audio content, etc.

The digital card display 704 may be triggered when a user at a transmitting device selects which particular digital card to exchange. The digital card display 704 may additionally provide functionality for the transmitting user to edit the digital card before exchanging it.

The digital card display 704 may be additionally triggered when a user at a receiving device receives a digital card either from a transmitting user device or from a server. Once received, the received digital card may be associated with the user account of the receiving user on the server, may be saved to a digital card database on the receiving user device, or both. An association of a received digital card with a user account may be achieved using a join table, or another cross-referencing identifier.

Referring now to FIG. 8, there is shown another example of a user device interface 850 used to control the privacy settings of a digital card. The digital card 854 may have one or more privacy settings associated with it, for example, public, private, and protected. Further, in some cases, each field on the digital card 854 may also have one or more privacy settings associated with it, for example, public, private, and protected.

A public card may be selected by a user by interacting with the public indicia 858 on a privacy setting window 856. A digital card, when set to a public setting, can be forwarded by a receiving user to any third-party user of a digital card exchange system, such as system 100 of FIG. 1, without any restrictions. In the case where there is a private field on a public card, the public card may be forwarded by a receiving user, however the transmitted card may not include the private field. In the case where there is a protected field on a public card, the public card may be forwarded by a receiving user, however the transmitted card may conditionally show the protected field subject to the approval of the digital card creator or owner. An example of a public card with a private field may be a digital card having both business information (such as, for example, business address, business telephone, and business email fields), along with personal information (such as, for example, personal phone, personal address, and personal email fields). The recipient of such an example card may receive all the business and personal information associated with the digital card, but if the example card is forwarded to a third-party, the personal information, if set to a private setting, will not be sent.

A private card may be selected by a user by interacting with the private indicia 760 on a privacy setting window 856. A digital card, if marked private, cannot be forwarded by a receiving user to any third-party user of a digital card exchange system, such as system 100 of FIG. 1.

A protected card may be selected by a user by interacting with the protected indicia 862 on a privacy setting window 856. A digital card, if marked protected, can only be forwarded by a receiving user to any third-party user of a digital card exchange system, such as system 100 of FIG. 1, if the owner or original creator of the digital card approves the exchange.

Reference is made to FIG. 9A, which shows an example map interface for exchanging digital cards according to an example. A user operating user device 902 may select the map interface on a card exchange application to view nearby users 904, who are subscribers of a digital card exchange system, such as the digital card exchange system 100 of FIG. 1. A user's consent may be required for the user or the user device to be displayed on the map interface of other users. The user may provide consent by, for example, adjusting a setting field in the user's account preferences. The map view may provide a view of other nearby users 904 and their general location with respect to the user operating the user device 902 based upon information signals received by device 902.

In the illustrated embodiment, in the map interface, the user device 902 receives and processes all information signals from all user devices, whether the information signal indicates a ‘transmit’ intent or a ‘receive’ intent.

The nearby users 904 may be represented by icons as shown. The icons may be sized based upon the signal strengths of the information signals transmitted by neighboring user devices 904, as perceived by the user device 902.

The position of user icons 904 within relief lines 906 may also be based on the signal strengths of the information signals transmitted by the user devices 904 relative to the receiving device 902. The distance indicators 906 signify the proximity of the nearby user devices corresponding to user icons 904 to the user device 902. As shown, the distance indicator 906a corresponds to a distance closer to the user device 902 than the distance indicator 906b and 906c, with distance indicator 906b being closer to the user device 902 than distance indicator 906c.

In most cases, the position of user icons 904 is additionally based on the orientation information contained within the information signals received from the user devices 904. The user device 902 displays the user icons 904 based on the relative position of the user device 904 with respect to the user device 902.

As shown, the positions of user icons 904a and 904d indicate that the user devices corresponding to the user icons 904a and 904d are to the left of the user operating the user device 902, where user device corresponding to user icon 904a is in front of user device 902 and user device corresponding to user icon 904d is behind the user device 902. The positions of user icons 904a and 904d further indicates that the user device corresponding to user icon 904a is closer to the user device 902 than the user device corresponding to user icon 904d.

Similarly, the positions of user icons 904d, 904c and 904e indicate that the user device corresponding to user icon 904c is closest to the user device 902, whereas user device corresponding to user icon 904b is in front of the user device 902 and the user device corresponding to user icon 904e is behind the user device 902.

The user at device 902 may interact and select a nearby user icon 904, and if the selected nearby user 904 has a digital card marked as public, the user at device 902 may choose to receive it. The user at device 902 may do so by clicking, tapping, or using a swipe down gesture, etc., on the user icon 904 to receive the public digital card of the user corresponding to the selected user icon 904.

Reference is made to FIG. 9B, which shows another example map interface 910 for exchanging digital cards according to an example. A user operating user device 912 may select the map interface on a card exchange application to view nearby users 914, who are subscribers of a digital card exchange system, such as the digital card exchange system 100 of FIG. 1. A user's consent may be required for their display on the map interface of other users. For example, a user may opt-in by selecting a setting field in the user's account preferences. The map view may provide a view of other nearby users 914 and their general location with respect to the user operating the user device 912 based upon a plurality of user geographical data provided by a server.

Upon loading the map interface 910, the digital card exchange application on device 912 may send a geographical search request to the remote service (see 102, FIG. 1). The geographical search request may include the geographical coordinates of the current user at the user device 912. The server may provide geographical search results based on the geographical search request. The geographical search results may include a listing of user accounts, and a listing of geographical coordinates (such as latitude and longitude) identifying the geographical location of each user on a map. The device 912 may render the identified user accounts 914 on a map as user icons, for example, superimposed on the map created from Google® Maps®, or another such map provider. The searching user at device 912 may tap or click on a user icon associated with a user and see a digital card associated with the user. The user may save the digital card, and by doing so the digital card may be associated with their user account on the digital card system 102 (see FIG. 1).

In one embodiment, a user may mark themselves as publically available for a period of time. For example, a user may indicate that he/she is available for a coffee or for lunch. The user may additionally opt to select a digital card that will be associated with their user icon on the map view 910. The user may also select an icon associated with their user display on map view 910. In marking themselves publically available, the user may also add an expiry time so that he/she will be displayed on the map view for a limited period of time. In another embodiment, a user may drop their card at a particular set of GPS coordinates such that others may pick their card up at a later time.

Reference is next made to FIG. 9C, which shows an example process flow diagram for picking up a digital card at a geographical location. The process flow 920 of FIG. 9C may by the various components of a digital card exchange system, such as system 100 of FIG. 1.

The process flow begins at 922, where a user device, such as user device 110 of FIG. 1, determines a geographical location associated with the user device. The geographical location of the user device 110 may be determined based on GPS coordinates of the location of the user device 110. At 924, the user device 110 is configured to transmit a geographical search request to a digital card management system, such as system 102 of FIG. 1. The geographical search request includes the geographical coordinates of the user device 110, as well as a request for available digital cards in the vicinity of the location of the user device 110.

At 926, the user device 110 receives a geographical search response from digital card management system 102. The response includes information pertaining to one or more selected users who have indicated that they wish their digital cards to be picked up at the geographical location where the user device 110 is located. The one or more users may be selected from the candidate users based on parameters such as, whether a candidate user dropped off a card at a geographical location corresponding to the geographical location of the user device 110 for the card to be picked up by other users, whether a candidate user has marked himself/herself as being publically available at a geographical location corresponding to the geographical location of the user device 110, or whether a candidate user has otherwise indicated that he/she wishes to share his/her digital card at the geographical location where the user device 110 is located.

In the embodiment of FIG. 9C, the information pertaining to the selected users, as received from the digital card management system 102, includes respective digital card token(s) corresponding to the selected users, where the digital card token(s) identify the selected user's permission to share his/her digital card, as well as identifies the digital card or cards the user wishes to share. In addition, the information pertaining to the selected users, as received from the digital card management system 102, includes unique identifiers associated with the selected users.

At 928, the user device 110 generates a map view of the selected users. This may be an optional step, and instead, the selected users may be provided to the user device 110 in a list format, or any other format. In the embodiment of FIG. 9C, the map view generated by the user device 110 overlays the one or more selected users or user icons on a geographical map of the location where the user device 110 is located.

At 930, the user operating the user device 110 selects one of the one or more users displayed on the user device 110 to indicate that the user wishes to receive the digital card associated with that selected user. The user may make the selection by selecting an icon corresponding to the displayed users. The user device 110, accordingly, receives a selection input identifying one of the one or more displayed users.

At 932, the user device 110 transmits the digital card token or tokens associated with the selected user icons. The digital card token(s) are transmitted to the digital card management system 102 by the user device 110. This step may be an optional step. In some embodiments, where the digital card token(s) associated with selected users is not transmitted to the user device 110 at 926, the process flow includes transmitting a user identifier associated with the selected icon to the digital card management system 102. In such embodiments, the digital token(s) are not exchanged.

At 934, the user device 110 receives the digital card or cards associated with the selected user icon from the digital card management system 102.

In some cases (not shown), steps 932 and 934 may be eliminated from the process flow. Instead, when, at 930, a selection input is received from the user operating the user device 110, the digital card, or a processed version of the digital card, previously consented to be shared with other users is transmitted to the user device 110. In other words, some users may already designate one or more of their digital cards or processed versions of their digital card to be ‘picked-up’ by other users. In such cases, such designated cards are automatically provided to the user device 110 if the user operating the user device 110 selects the user icon corresponding to such designated card(s).

Reference is next made to FIG. 9D, which shows an example process flow diagram for dropping a digital card at a geographical location. The process flow 960 of FIG. 9D may by the various components of a digital card exchange system, such as system 100 of FIG. 1.

The process flow 960 begins at 962, where a user device, such as user device 110 of FIG. 1, determines a geographical location associated with the user device. The geographical location of the user device 110 may be determined based on GPS coordinates of the location of the user device 110.

At 964, the user device 110 receives a selection input from the user operating the user device 110, where the selection input identifies a digital card or cards that the user wishes to drop off at a location, or wishes to be picked up from a location.

At 966, the user device 110 generates a signed digital token for each of the one or more digital cards that the user wishes to drop off at a location. The digital token or tokens are signed using the private key associated with the user operating the user device 110. This is explained in detail below.

At 968, the user device 110 transmits a digital card drop request to a digital card management system, such as system 102 of FIG. 1. The digital card drop request includes the geographical location of the user device 110 and the signed digital card token or tokens which facilitates access to the digital card or cards the user operating the user device 110 wishes to share with other users.

In some cases (not shown), the user device 110 may prompt the user to indicate an expiration time, a time duration or any other indicator of time identifying the time for which the dropped off digital card(s) remains valid.

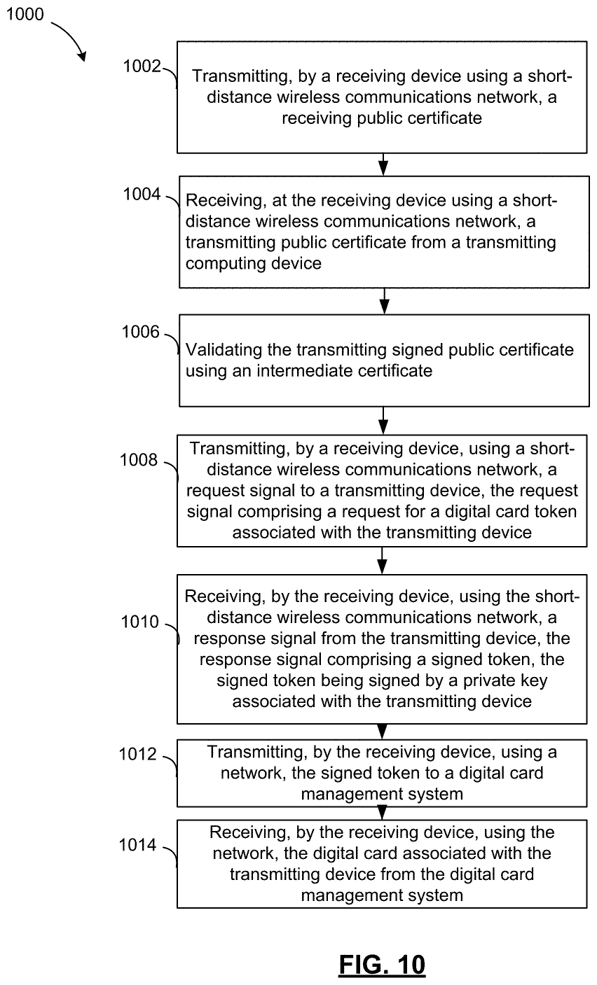

Reference is next made to FIG. 10, which shows an example process flow diagram 1000 of a connection method for transferring digital cards. When a user creates an account on a digital card management system, such as the digital card management system 102 of FIG. 1, a unique user identifier and a unique device identifier may be generated for the user. The unique user identifier uniquely identifies the user subscribing to a digital card exchange system, such as system 100 of FIG. 1. The unique device identifier uniquely identifies the user device associated with the user. The digital card management system 102 stores the unique user and device identifiers, as shown in various embodiments herein, such as, for example, FIGS. 3A-3D. The unique user identifier may be used to generate an authentication token when the user logs into the digital card management system 102. In some cases, one or the other of the unique user identifier and a unique device identifier are generated for the user.

When a subscribed user operating a user device logs into the user's account at the digital card management system for the first time (using, for example, a card exchange application on the user device), a private key and a certificate signing request signal (CSR) are generated by the user device. The CSR contains a public key that is used to decrypt communications encrypted using the corresponding private key generated at the user device, or encrypt communications that can be decrypted using the corresponding private key. The CSR is transmitted to the digital card management system 102.

The certificate module 326 (see FIG. 3) of digital card management system 102 receives the CSR and in response, generates a signed public certificate corresponding to the user device. The signed public certificate is transmitted back to the user device from certificate module 326 (see FIG. 3) of the digital card management system 102, and is safely stored in the memory module of the user device for future use.

The process flow illustrated in FIG. 10 is engaged once the ideal transmitting device is identified by the receiving device, as discussed in detail in various embodiments herein, such as, for example, the process discussed in FIG. 5. For east of reference, the ideal transmitting device is interchangeably referred to as the transmitting device in the discussion below.

Process flow 1000 begins at 1002, where a receiving signed certificate associated with a receiving device is transmitted to the identified ideal transmitting device using a short-distance wireless communications network, such as local network 112 of FIG. 1. The receiving signed public certificate is the signed public certificate stored in the memory module of the receiving device, as discussed above.

At 1004, the receiving device receives the transmitting signed public certificate of the ideal transmitting device. This may be sent using a short-distance wireless communications network, such as local network 112 of FIG. 1.

Steps 1002 and 1004 taken together may be referred to as a public certificate exchange step.

At 1006, the transmitting signed public certificate is validated using an intermediate certificate that was used to sign the public certificate at the certificate module 326 of the digital card management system 102 in the first place. The validation process may be performed by the validation engine 227 of the user device (see FIG. 2).

The certificate validation process may provide the advantage of identifying unscrupulous, corrupt or fraud entities that may be trying to misrepresent themselves as authorized subscribers of the digital card exchange system 100 of FIG. 1. Assuming the certificate validation process is successful, the process flow proceeds to step 1008. Although not shown, the ideal transmitting device receiving the receiving signed certificate associated with a receiving device may similarly validate the receiving signed public certificate using an intermediate certificate at the ideal transmitting device.

At 1008, a request signal is transmitted to the ideal transmitting device using a short-distance wireless communications network, such as local network 112 of FIG. 1. The request signal contains a request for a digital card token from the ideal transmitting device. In most cases, the request signal is transmitted to the ideal transmitting device by the receiving device if the receiving device detects the presence of a network other than the short-distance wireless communications network, such as network 108 of FIG. 1.

At 1010, a response signal is transmitted by the ideal transmitting device to the receiving device. The response signal contains a signed token. The signed token is signed by a private key associated with the transmitting device. The response signal is transmitted from the ideal transmitting device to the receiving device using the short-distance wireless communications network, such as local network 112.

At 1012, the signed token is transmitted to a digital card management system, such as system 102, by the receiving device using network 108. In most cases, the signed token includes a unique identifier associated with the user operating the transmitting device, and a digital card identifier associated with the digital card associated with transmitting device. In some other cases, the signed token may additionally include an authentication token associated with the user operating the transmitting device. In some further cases, the signed token may additionally include a unique device identifier associated with the transmitting device. This may be the case when the user operating the ideal transmitting device has multiple transmitting devices registered under his/her identifier. In some other cases, where multiple digital cards are registered under the user identifier, the signed token also identifies the digital card or cards the ideal transmitting device wishes to exchange with the receiving device.

In one embodiment, the signed token also includes a unique identifier associated with the user operating the receiving device. The unique identifier associated with the receiving device user may be made available to the transmitting device from the request signal received from the receiving device. In some cases, the signed token may include the unique identifier associated with the receiving device instead of (or in addition to) the unique identifier associated with the receiving device user.

In another embodiment, the signed token may not include the unique identifier associated with the receiving device or the user operating the receiving device. In such cases, the receiving device may transmit other information, such as the unique identifier associated with the receiving device and/or the receiving device user, along with the signed token to the digital card management system.

In some cases, the receiving device may additionally send information, such as a geographical location of the transaction between the transmitting device and the receiving device, event information relating to the transaction between the transmitting device and the receiving device, an expiry of the signed token, etc. along with the signed token to the digital card management system.

The digital card management system verifies the signed token using the signed public certificate of the transmitting device stored on the system 102. Once verified, the system 102 locates the digital card or cards of the ideal transmitting device that the user operating the ideal transmitting device wishes to transmit to the receiving device.

At 1014, a digital card (or cards) associated with the ideal transmitting device is received from the system 102. The digital card may be added to an address book at the receiving user device. In addition, the system 102 may update its records, such as records shown in FIGS. 3B-3D, to identify this exchange.

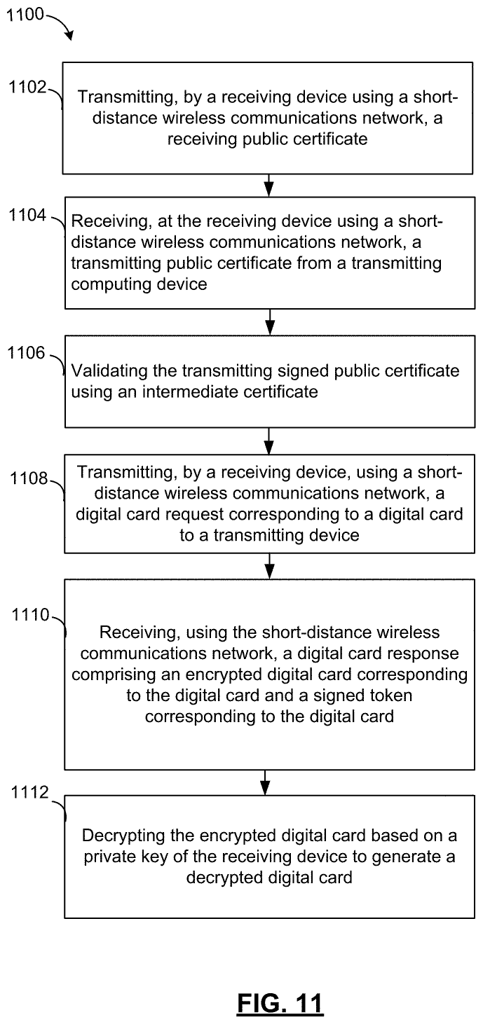

Reference is next made to FIG. 11, which shows an example of a process flow diagram 1100 showing another connection method for exchanging digital cards. Method 1100 may be used when either the receiving user device, the ideal transmitting device, or both devices lack network access for communication with a digital card management system, such as network 108 of FIG. 1.

Steps 1102, 1104 and 1106 of process flow 1100 are analogous to steps 1002, 1004 and 1006 of FIG. 10.

At 1108, a request signal is transmitted by the receiving device to the ideal transmitting device using a short-distance wireless communications network, such as network 112. The request signal contains a digital card request from the ideal transmitting device. This request is sent by the receiving device when the receiving device detects that a network other than the short-distance wireless communication network, such as network 108 of FIG. 1, is unavailable to the receiving device.

Upon receiving the request signal, the ideal transmitting device may process a local version of the digital card it wishes to exchange with the receiving device. The local version of the digital card may be processed in different formats, including an object representation of the digital card, an image of a digital card, etc. The processed digital card image may be, for example, a Portable Network Graphic (PNG) file. In some other cases, the processed card image may include digital card data, a digital card template, or a reference to a cached image. The processed version or image of the card may be substantially smaller in file size than a full resolution version or image of the digital card.

In some cases, a processed version of the digital card may be pre-stored on the ideal transmitting device in one or more image qualities or versions. For example, an uncompressed version of the digital card image and a compressed version of the digital card image may be pre-stored in the device.

The ideal transmitting device transmits a digital card response to the receiving device. In most cases, the ideal transmitting device encrypts the processed version of the digital card using the signed public certificate of the receiving device, and transmits the encrypted version to the receiving device. The signed certificate of the receiving user is accessible to the ideal transmitting device from the earlier signed certificate exchange step.

The digital card response may additionally comprise a signed token generated by the ideal transmitting device. The signed token of FIG. 11 is analogous to the signed token disclosed in FIG. 10 discussion.

At 1110, the digital card response including the encrypted digital card and in some cases, additionally the signed token, is received by the receiving device from the ideal transmitting device using a short-distance communications network, such as local network 112.

At 1112, the encrypted digital card is decrypted by the receiving device using the private key associated with the user of the receiving device. Once decrypted, the decrypted digital card may be added to an address book at the receiving user device.

Subsequently (not shown), when the receiving device returns to network connectivity with network 108 of FIG. 1, the receiving device may send the signed token to the digital card management system. The digital card management system may process the signed token normally, as described at 1012 and 1014 (see FIG. 10) above, and send the digital card to the receiving device. The digital card sent from the digital card management system to the receiving device is a higher quality card than the decrypted card.

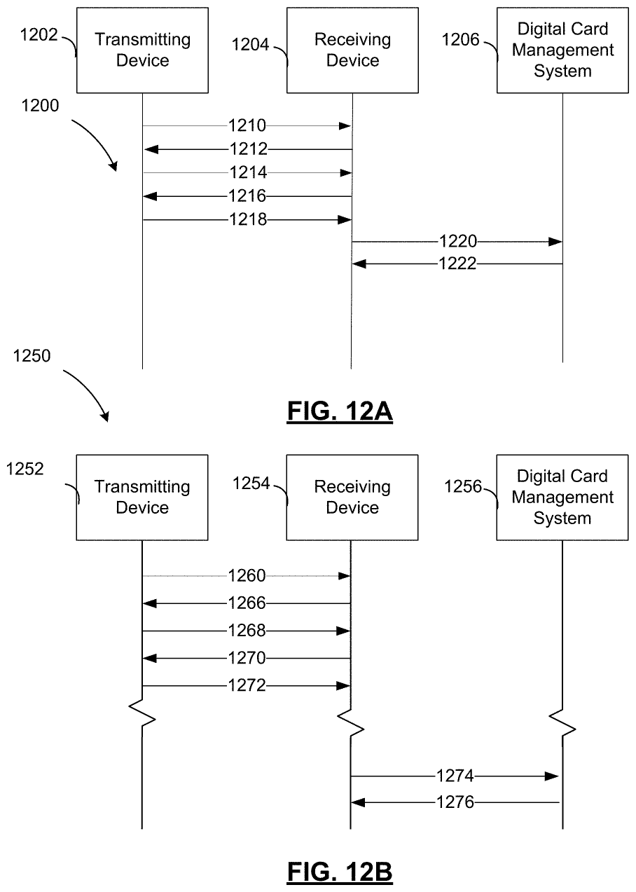

Reference is next made to FIG. 12A, which shows an example of a data flow diagram 1200 for exchanging digital cards. Data flow diagram 1200 shows a transmitting device 1202, a receiving device 1204, and digital card management system 1206. Data flow diagram 1200 represents the method of FIG. 10 where the receiving user device 1204 is in network communication with the digital card management system 1206 using network 108.

Message 1210, transmitted by the transmitting device 1202, includes one or more information signals, with each information signal including a unique identifier associated with the transmitting device 1202, a user identifier of the user operating the transmitting device 1202, and orientation information of the transmitting device 1202. The receiving device may use the discovery method described herein, such as in FIG. 5, to determine that the transmitting device 1202 is the ideal transmitting device.

Message 1212 is transmitted from receiving device 1204 to transmitting device 1202, and includes the signed public certificate associated with the receiving device 1204. The signed public certificate associated with the receiving device may be a public cryptographic key issued by the digital card management system 1206.

Message 1214 is transmitted from transmitting device 1202 to receiving device 1204, and includes the signed public certificate associated with the transmitting device 1202. The signed public certificate associated with the transmitting device may be a public cryptographic key issued by the digital card management system 1206.

The transmitting device 1202 may validate the public certificate of the receiving device 1204 using an intermediate certificate bundled with a software application at the device. The validation of the public certificate of the receiving device 1204 involves verifying the signature of the public certificate. The receiving device 1204 may also validate the public certificate of the transmitting device 1202 using an intermediate certificate bundled with a software application at the device. The validation of the public certificate of the transmitting device 1202 may involve checking the signature of the public certificate. In the case that either the transmitting device 1202 or the receiving device 1204 has a validation failure, the connection between the transmitting device 1202 and the receiving device 1204 fails.

Message 1216 is a request for signed token transmitted by the receiving device 1204 to the transmitting device 1202. The request for the signed token indicates that the receiving device 1204 wishes to receive a digital card associated with the transmitting device 1202, or the user operating the transmitting device 1202.

Message 1218 contains the signed token transmitted by the transmitting device 1202 to the receiving device 1204. The signed token is signed by the private key of the transmitting device 1202. The signed token includes the user identifier associated with the user operating the transmitting device 1202, optionally the unique identifier associated with the transmitting device 1202, optionally an authentication token associated with the user at the transmitting device 1202, and optionally an identifier for the digital card that the transmitting device 1202 wishes to exchange with the receiving device 1204. The signed token may also include a unique identifier associated with the receiving device 1204 or the user operating the receiving device 1204.

Message 1220 is sent by the receiving device 1204 to the digital card management system 1206 (see e.g. 102 in FIG. 1). Message 1220 includes the signed token received in message 1218 from the transmitting device. In some cases, where the signed token does not include the unique identifier associated with the receiving device 1204 or the user operating the receiving device 1204, the message 1220 additionally includes the unique identifier associated with the receiving device 1204 or the user operating the receiving device 1204.

The digital card management system 1206 verifies the signed token sent by the transmitting device 1202 contained in the message 1220, and determines a digital card identifier for the digital card to be provided to the receiving device 1204. The digital card management system 1206 may create an association between the user at the receiving device 1204 and the digital card identifier associated with the message 1220. Optionally, the digital card management system 1206 may also create an association between the user at the transmitting device 1202 and the user at the receiving device 1204.

Message 1222 is sent by the digital card management system 1206 to the receiving device 1204, and includes the digital card identified by the digital card management system 1206 from the message 1220. The receiving device 1204 may add the digital card to the address book at the receiving device 1204.

Reference is next made to FIG. 12B, which shows another example of a data flow diagram for exchanging digital cards. Data flow diagram 1250 has a transmitting device 1252, a receiving device 1254, and a digital card management system 1256. Data flow diagram 1250 represents the method of FIG. 11 where either the receiving user device, the ideal transmitting device, or both lack the availability of a network to communicate with system 1256.

Message 1260 includes one or more information signals transmitted by transmitting device 1252. Receiving device 1254 receives the information signal from transmitting device 1252. Based on the transmitted information signals of the transmitting device 1252, and other transmitting devices in the vicinity (not shown) (based on, for example, FIG. 5), the receiving device 1254 may identify the transmitting device 1252 as the ideal transmitting device.

Messages 1266 and 1268 are analogous to messages 1212 and 1214 of FIG. 12A.

Message 1270 is transmitted from receiving device 1254 to transmitting device 1252. The message 1270 includes a digital card request, which includes a request to the transmitting device 1252 to transmit a digital card to the receiving device 1254.

Message 1272 is transmitted by the transmitting device 1252 to the receiving device 1254, and includes an encrypted digital card and a signed token. The encrypted digital card is encrypted using the public certificate associated with the user operating the receiving device 1254. The encrypted digital card may include a processed digital card, as described above.

The receiving device 1254 receives the encrypted digital card, and decrypts it using the private key associated with the user operating the receiving device 1254. The receiving device 1254 may add the decrypted digital card to the address book on the receiving device.

Message 1274 is subsequently sent to digital card management system 1256 from receiving device 1254 when the receiving device 1254 is able to communicate with the system 1256 using network 108. Message 1274 includes the signed token of message 1272, and optionally the unique identifier associated with the receiving device 1254 or the user operating the receiving device 1254.

The digital card management system 1256, upon receiving the message 1274, validates the signed token in message 1272 using the signed public certificate of the transmitting device 1252, identifies the digital card to be transmitted to the receiving device 1254, and the identity of the receiving device 1254 based on the unique identifiers included in message 1274.

In some cases, the digital card management system 1256 may add an association between the transmitting user at the transmitting device 1252 and the receiving user at the receiving device 1254.

Message 1276 is sent from the digital card management system 1256 to the receiving device 1254, and includes the digital card associated with the transmitting user at the transmitting device 1252. The digital card included in message 1276 may be a detailed version of the digital card, and may be added to the address book of receiving device 1254 upon receipt.

Various embodiments have been described herein by way of example only. Various modification and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

We claim:

1. A system for receiving a digital card, comprising:
one or more transmitting devices, each of the one or more transmitting devices comprising:
a first wireless transceiver; and
a first processor configured to:
encode a device orientation indicia in a first plurality of information signals; and
transmit, using the first wireless transceiver, the first plurality of information signals; and
a second computing device, the second computing device comprising:
a second wireless transceiver; and
a second processor configured to:
receive a plurality of incoming information signals from the second wireless transceiver, the plurality of incoming information signals corresponding to the one or more transmitting devices, each of the plurality of incoming information signals having a corresponding device orientation indicia, and the plurality of incoming information signals comprising at least one of the first plurality of information signals;
determine a signal strength of each incoming information signal;
determine an ideal transmitting device from the one or more transmitting devices based on the device orientation indicia and the signal strength of each incoming information signal; and
establish a connection with the ideal transmitting device.

2. The system of claim 1, wherein each transmitting device further comprises a device orientation sensor, and the device orientation indicia corresponding to that transmitting device is based on a measurement by the device orientation sensor.

3. The system of claim 1, wherein the second processor is further configured to determine an offset angle for each incoming information signal based on a receiving device orientation and the device orientation indicia contained in that information signal, and wherein the ideal transmitting device is determined based on the offset angle and the signal strength of each incoming information signal.

4. The system of claim 3, wherein the second processor is further configured to
determine a ranking score for each of the plurality of incoming information signals, the ranking score determined based on a weighted linear combination of the signal strength and the offset angle; and
identify the ideal transmitting based on the incoming information signal with a highest ranking score.

5. The system of claim 3, wherein the second processor is further configured to:
filter the plurality of incoming information signals based on a signal strength threshold, wherein the one or more information signals with a corresponding signal strength higher than the signal strength threshold are grouped to identify a first set of qualifying information signals;
filter the first set of qualifying information signals based on an orientation threshold, wherein the one or more information signals from the first set of qualifying information signals with an offset angle smaller than the orientation threshold are grouped to identify a second set of qualifying information signals; and
rank the second set of qualifying information signals based on the corresponding signal strengths.

6. The system of claim 2, wherein the first orientation sensor is a magnetic compass located within the corresponding transmitting device.

7. The system of claim 6, wherein the plurality of information signals are transmitted using a short-distance wireless communications network.

8. The system of claim 7, wherein the short-distance wireless communications network is a Bluetooth Low Energy based network.

9. The system of claim 1, wherein the second computing device further comprises a second display user interface, wherein the second processor is further configured to:
display the one or more transmitting devices associated with the plurality of incoming information signals on a map on the second display user interface, wherein the location of each transmitting device on the map is based on the signal strength and the device orientation indicia associated with the corresponding information signal.

10. A method of receiving a digital card, comprising:
receiving, at a receiving device, one or more incoming information signals, the one or more incoming information signals corresponding to one or more transmitting devices, each of the one or more incoming information signals having a device orientation indicia;
determining, at the receiving device, an offset angle for each incoming information signal based on a receiving device orientation and the device orientation indicia contained in the corresponding incoming information signal;
determining a signal strength of each incoming information signal;
determining an ideal transmitting device based on the offset angle and the signal strength of each information signal; and
establishing the connection between the ideal transmitting device and the receiving device.

11. The method of claim 10, wherein the determining the ideal transmitting device further comprises:
determining a ranking score for each of the plurality of incoming information signals, the ranking score determined based on a weighted linear combination of the signal strength and the offset angle; and
identifying the ideal transmitting based on the incoming information signal with a highest ranking score.

12. The method of claim 10, wherein the determining the ideal transmitting device further comprises:
filtering the plurality of incoming information signals based on a signal strength threshold, wherein the one or more information signals with a corresponding signal strength higher than the signal strength threshold are grouped to identify a first set of qualifying information signals;
filtering the first set of qualifying information signals based on an orientation threshold, wherein the one or more information signals from the first set of qualifying information signals with an offset angle smaller than the orientation threshold are grouped to identify a second set of qualifying information signals; and
ranking the second set of qualifying information signals based on the corresponding signal strengths.

13. The method of claim 12, wherein the plurality of incoming information signals are transmitted using a short-distance wireless communications network.

14. The method of claim 13, wherein the short-distance wireless communications network is a Bluetooth Low Energy based network.

15. The method of claim 10, further comprising:
displaying the one or more transmitting devices associated with the plurality of incoming information signals on a map on a second display user interface, wherein the location of each transmitting device on the map is based on the signal strength and the device orientation indicia associated with the corresponding information signal.

16. A system for receiving a digital card, comprising:
a transmitting device, the transmitting device comprising:
a transmitting device wireless transceiver; and
a transmitting device processor being configured to:
receive, using the transmitting device wireless transceiver, a signed public certificate from a receiving device;
validate the signed public certificate received from the receiving device;
transmit, using the transmitting device wireless transceiver, a signed public certificate associated with the transmitting device to the receiving device;
receive, using the transmitting device wireless transceiver, a request signal from the receiving device, the request signal including a request for a digital card associated with a transmitting device;
generate, a signed token in response to the request signal, the signed token being signed using a private key associated with the transmitting device; and
transmit, using the transmitting device wireless transceiver, the signed token to the receiving device; and
the receiving device comprising:
a receiving device wireless transceiver; and
a receiving device processor being configured to:
transmit, using the receiving device wireless transceiver, the signed public certificate associated with the receiving device to the transmitting device;
receive, using the receiving device wireless transceiver, the signed public certificate associated with the transmitting device;
validate the signed public certificate associated with the transmitting device;
transmit, using the receiving device wireless transceiver, the request signal to the transmitting device;
receive, using the receiving device wireless transceiver, the signed token from the transmitting device;
transmit, using a network, the signed token to a digital card management system; and
receive, using the network, a digital card associated with the transmitting device from the digital card management system, the digital card being identified in the signed token.

17. A method of receiving a digital card, comprising:
transmitting, by a receiving device, using a short-distance wireless communications network, a signed public certificate associated with the receiving device;
receiving, at the receiving device, using a short-distance wireless communications network, a signed public certificate associated with a transmitting device;
validating the signed public certificate associated with the transmitting device;
transmitting, by the receiving device, using the short-distance wireless communications network, a request signal to the transmitting device, the request signal comprising a request for a digital card associated with the transmitting device;
receiving, by the receiving device, using the short-distance wireless communications network, a response signal from the transmitting device, the response signal comprising a signed token, the signed token being signed by a private key associated with the transmitting device;
transmitting, by the receiving device, using a network, the signed token to a digital card management system; and
receiving, by the receiving device, using the network, the digital card associated with the transmitting device from the digital card management system.

18. A system of receiving a digital card, comprising:
a transmitting device, the transmitting device comprising:
a transmitting device wireless transceiver;
a signed public certificate associated with the transmitting device; and
a transmitting device processor being configured to:
receive, using the transmitting device wireless transceiver via a short-distance communications network, a signed public certificate associated with a receiving device from the receiving device;
validating the signed public certificate associated with the receiving device;
transmit, using the transmitting wireless transceiver, the signed public certificate associated with the transmitting device to the receiving device;
receive a digital card request corresponding to a digital card associated with the transmitting device, the digital card request being generated by the receiving device;
generate a response signal, the response signal comprising an encrypted digital card and a signed token, the encrypted digital card being encrypted based on the signed public certificate associated with the receiving device; and
transmit, using the transmitting device wireless transceiver, the response signal to the receiving device;
the receiving device comprising:
a receiving device wireless transceiver;
the signed public certificate associated with the receiving device; and
a receiving device processor being configured to:
transmit, using the receiving device wireless transceiver via the short-distance communications network, the signed public certificate associated with the receiving device to the transmitting device;
receive, using the receiving device wireless transceiver via the short-distance communications network, the signed public certificate associated with the transmitting device from the transmitting device;
validate the signed public certificate associated with the transmitting device;
transmit, using the receiving device wireless transceiver via the short-distance communications network, the digital card request to the transmitting device;
receive, using the receiving device wireless transceiver via the short-distance communications network, the response signal; and
decrypting the encrypted digital card in the response signal based on a private key associated with the receiving device to generate a decrypted digital card.

19. The system of claim 18, wherein the receiving device processor is further configured to:
subsequently transmit, using a network, the signed token in the response signal to a digital card management system; and
receive, using the network, from the digital card management system, the digital card identified in the response signal.

20. A method of receiving a digital card, comprising:
transmitting, by a receiving device using a short-distance wireless communications network, a public certificate associated with the receiving device;
receiving, at the receiving device using a short-distance wireless communications network, a public certificate associated with the transmitting device from a transmitting computing device;
validating the signed public certificate associated with the transmitting device;
transmitting, by the receiving device, using a short-distance wireless communications network, a digital card request corresponding to the digital card to the transmitting device;
receiving, using the short-distance wireless communications network, a response signal, the response signal comprising an encrypted digital card corresponding to the digital card and a signed token, the encrypted digital card being an encrypted version of the digital card associated with the transmitting device, the encrypted digital card being encrypted based on the signed public certificate associated with the receiving device; and
decrypting the encrypted digital card based on a private key associated with the receiving device to generate a decrypted digital card.

21. The method of claim 20, further comprising:
subsequently, transmitting using a network, the signed token to a digital card management system; and
receiving using the network, from the digital card management system, the digital card.

22. A system of receiving a digital card, comprising:
a computing device, the computing device comprising:
a geographical location sensor; and
a processor, the processor being configured to:
determine, a user geographical location of the computing device using the geographical location sensor;
transmit, a geographical search request to a server, the geographical search request including the geographical location of the computing device;
receive, a geographical search response from the server; the geographical search response including one or more user identifiers, and a corresponding one or more digital card tokens;
display a map view including one or more user icons on a display device, wherein each of the one or more user icons are arranged on the map view based on the corresponding geographical location;
receive a selection input, the selection input identifying a user icon from the one or more user icons arranged on the map view;
transmit the digital card token associated with the selected user icon to the server; and
receive a digital card corresponding to the selected user icon from the server.

23. A method of receiving a digital card, comprising:
determining, at a user device, a user geographical location of the user device;
transmitting, to a server, a geographical search request, the geographical search request including the geographical location of the user device;
receiving, from the server, a geographical search response, the geographical search response including one or more user identifiers and one or more corresponding digital card tokens;
displaying a map view including one or more user icons associated with the one or more user identifiers, wherein each of the one or more user icons are arranged on the map view based on the corresponding geographical location;
receiving, at a user input device, a selection input, the selection input identifying a user icon from the one or more user icons arranged on the map view;
transmitting, to the server, the digital card token associated with the selected user icon; and
receiving, from the server, a digital card corresponding to the selected user icon.

24. A system of transmitting a digital card, comprising:
a computing device, the computing device comprising:
a memory including a digital card and a signed public certificate;
a geographical location sensor; and
a processor, the processor being configured to:
determine, a geographical location of the computing device using the geographical location sensor;
receive a selection input from a user operating the computing device, the selection input identifying the digital card from one or more digital cards to be exchanged;
generate a signed digital card token based on the selected digital card, the signed digital card token being signed with a private key associated with the computing device; and
transmit a digital card drop request to a server, the digital card drop request comprising the geographical location of the computing device and the signed digital card token.

25. A method of transmitting a digital card, comprising:
determining, at a user device, a geographical location of the user device;
receiving, at a user input device, a selection input from a user operating the computing device, the selection input identifying the digital card from one or more digital cards to be exchanged;
generating, at the user device, a signed digital card token based on the selected digital card, the signed digital card token being signed with a private key associated with the computing device; and
transmitting, to a server, a digital card drop request, the digital card drop request comprising the geographical location of the computing device and the signed digital card token.
